(19) United States
(12) Patent Application Publication
(10) Pub. No.: US 2008/0286606 A1
(43) Pub. Date: Nov. 20, 2008

(54) ORGANIC LIGHT EMITTING DIODE AND FLAT PANEL DEVICE INCLUDING THE SAME

(75) Inventors: Seok-Hwan Hwang, Suwon-si (KR); Young-Kook Kim, Suwon-si (KR); Yoon-Hyun Kwak, Suwon-si (KR); Hee-Joo Ko, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/122,143

(22) Filed: May 16, 2008

(30) Foreign Application Priority Data
May 16, 2007 (KR) 2007-47850

(51) Int. Cl. B32B 9/00; C09K 11/00

(52) U.S. Cl. 428/690

(57) ABSTRACT

An organic light emitting diode and a flat panel device including the same includes: a substrate; a first electrode formed on the substrate; a second electrode; and an organic layer disposed between the first electrode and the second electrode, wherein the organic layer comprises an emissive layer, a first hole injection layer, and a second hole injection layer, and at least one of the first hole injection layer and the second hole injection layer comprises a compound represented by Formula 1 below. The organic light emitting diode can have a relatively long life-time. Formula 1 is:

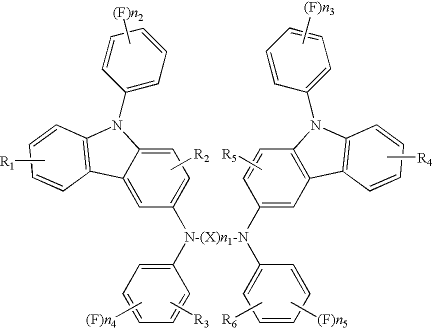

### CROSS-REFERENCE TO RELATED APPLICATIONS

This application claims the benefit of Korean Patent Application No. 2007-47850 filed on May 16, 2007, in the Korean Intellectual Property Office, the disclosure of which is incorporated herein by reference.

### BACKGROUND OF THE INVENTION

1. Field of the Invention

Aspects of the present invention relate to an organic light emitting diode and a flat display device including the same, and more particularly, to an organic light emitting diode including an organic layer that comprises a compound containing a fluorine group, which can trap electrons, disposed between a pair of electrodes, and a flat display device including the organic light emitting diode. The organic light emitting diode can have a relatively long life-time.

2. Description of the Related Art

Organic light emitting diodes are self-emissive diodes that operate based on the phenomenon that when current is supplied to a fluorescent or phosphorescent organic layer, electrons and holes recombine in the organic layer to emit light. Organic light emitting diodes are lightweight, include relatively few components, and are manufactured using relatively simple manufacturing processes. In addition, organic light emitting diodes can realize high image quality, obtain wide-viewing angles, and implement moving pictures. Furthermore, organic light emitting diodes have high color purity, can operate with low power consumption and low voltage, and have electrical properties suitable for portable electronic devices.

In general, to improve efficiency and lower turn-on voltage, organic light emitting diodes have a multi-layer structure including an electron injection layer, an emissive layer, a hole transport layer, and the like, instead of using only an emissive layer as an organic layer. For example, Japanese Patent Laid-Open Publication No. 2002-252089 discloses an organic light emitting diode including a hole transport layer.

In the case of a conventional organic light emitting diode, electrons passing through an emissive layer and the like collide with a hole injection layer. Such collisions lead to a decreased lifetime of the organic light emitting diode, and thus, an organic material forming an organic layer that can trap electrons is required.

### SUMMARY OF THE INVENTION

Aspects of the present invention provide an organic light emitting diode including an organic layer disposed between a pair of electrodes, and the organic layer comprises a compound containing at least one fluorine group that can trap electrons, thereby having electrical stability and high charge transporting ability, and a flat display device including the organic light emitting diode.

According to an aspect of the present invention, there is provided an organic light emitting diode comprising: a substrate; a first electrode formed on the substrate; a second electrode; and an organic layer disposed between the first electrode and the second electrode, wherein the organic layer comprises an emissive layer, a first hole injection layer, and a second hole injection layer, and at least one of the first hole injection layer and the second hole injection layer comprises a compound represented by Formula 1 below:

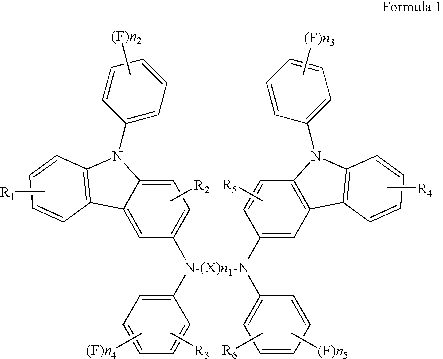

wherein X is a substituted or unsubstituted C₆-C₃₀ arylene group, a substituted or unsubstituted C₂-C₃₀ heteroarylene group or a substituted, or unsubstituted C₁-C₃₀ alkylene group; R₁, R₂, R₃, R₄, R₅, and R₆ are each independently a hydrogen atom, a hydroxyl group, a cyano group, a substituted or unsubstituted C₁-C₃₀ alkyl group, a substituted or unsubstituted C₁-C₃₀ alkoxy group, a substituted or unsubstituted C₆-C₃₀ aryl group, a substituted or unsubstituted C₆-C₃₀ aryloxy group, a substituted or unsubstituted C₂-C₃₀ heteroaryl group, or a group represented by —N(Z₁)(Z₂) where Z₁ and Z₂ are each independently hydrogen, a C₁-C₃₀ alkyl group, a C₁-C₃₀ alkoxy group, or a C₆-C₃₀ aryl group, and at least two adjacent groups of R₁, R₂, R₃, R₄, R₅, and R₆ may be bound to each other or fused with each other to form a saturated or unsaturated carbon ring; and n₁, n₂ n₃, n₄, and n₅ are each independently an integer of 0 through 5, provided that n₁, n₂, n₃, n₄, and n₅ are not all zero, wherein the compound represented by Formula 1 contains at least one F.

According to another aspect of the present invention, there is provided a flat display device comprising the organic light emitting diode and a thin film transistor, wherein a first electrode of the organic light emitting diode and a source electrode or drain electrode of the thin film transistor are electrically connected to each other, and the organic light emitting diode comprises the compound of Formula 1.

The organic light emitting diode according to aspects of the present invention can have long life-time.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other features and advantages of the aspects of the present invention will become more apparent by describing in detail exemplary embodiments thereof with reference to the attached drawings in which:

FIG. 1 is a schematic sectional view illustrating a structure of an organic light emitting diode according to an embodiment of the present invention;

FIG. 2 is a schematic sectional view of an organic light emitting diode including red, green, and blue emissive layers, according to an embodiment of the present invention; and

FIGS. 3 and 4 are graphs showing life-times of examples of organic light emitting diodes according to embodiments of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the aspects of the present invention by referring to the figures. It will be understood that when an element is referred to as being “connected to” or “formed on” another element, it may be directly connected to or directly formed on the other element or intervening elements may be present. In contrast, when an element is referred to as being “directly connected to” or “directly formed on” another element, there are no intervening elements present. Other words used to describe the relationship between elements should be interpreted in a like fashion (e.g., “between” versus “directly between”, “adjacent” versus “directly adjacent”, etc.).

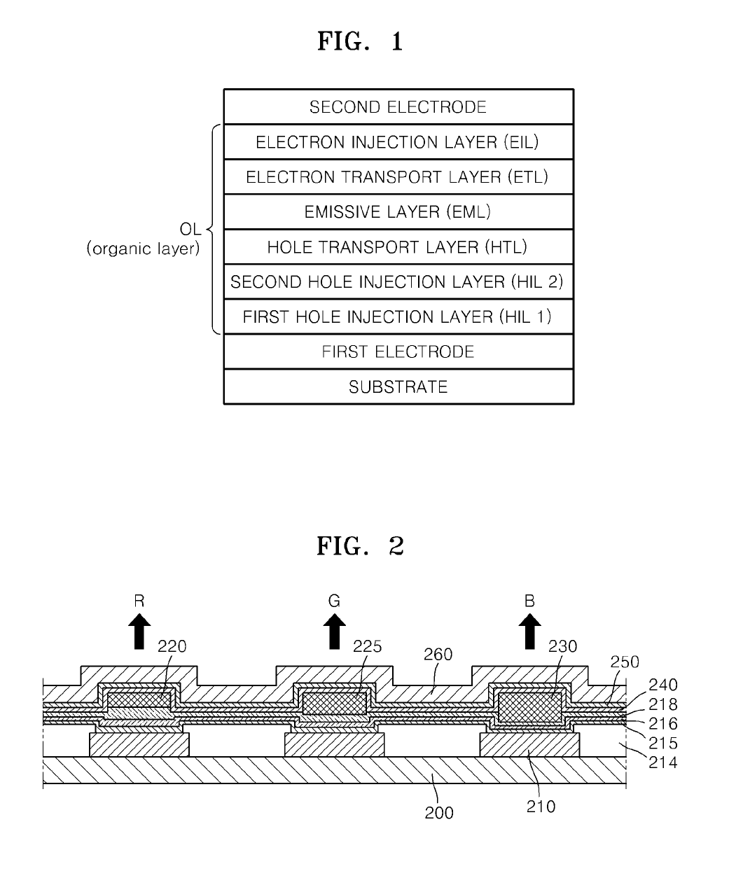

Aspects of the present invention will now be described more fully with reference to the accompanying drawings, in which exemplary embodiments of the invention are shown. With reference to FIG. 1, aspects of the present invention provide an organic light emitting diode that includes a substrate, a first electrode formed on the substrate, a second electrode and an organic layer (OL), wherein the organic layer (OL) is disposed between the first electrode and the second electrode, and includes an emissive layer (EML), a first hole injection layer (HIL 1), and a second hole injection layer (HIL 2). Further, the organic layer (OL) may include the organic light emitting diode may have a hole transport layer (HTL), and an electron transport layer (ETL), and an electron injection layer (EIL). The hole transport layer (HTL) may be disposed between the second hole injection layer (HIL 2) and the emissive layer (EML). And, the electron transport layer (ETL) and the electron injection layer (EIL) may be disposed between the emissive layer (EML) and the second electrode.

At least one of the first hole injection layer (HIL 1) and the second hole injection layer (HIL 2) of the organic layer (OL) of the organic light emitting diode may comprise a fluorine-containing compound. Further, the hole transport layer (HTL) may comprise the fluorine-containing compound. More particularly, the fluorine-containing compound may be a compound represented by Formula 1 below:

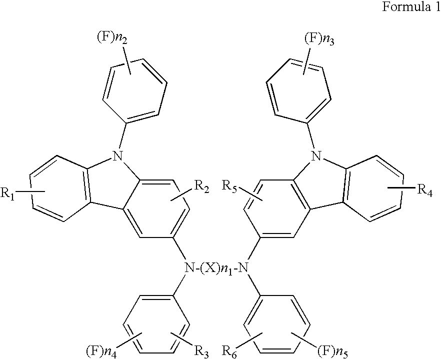

wherein X is a substituted or unsubstituted C₆-C₃₀ arylene group, a substituted or unsubstituted C₂-C₃₀ heteroarylene group, or a substituted or unsubstituted C₁-C₃₀ alkylene group.

More particularly, X may be one of a plurality of structures represented by Formula 2 below, but X is not limited thereto:

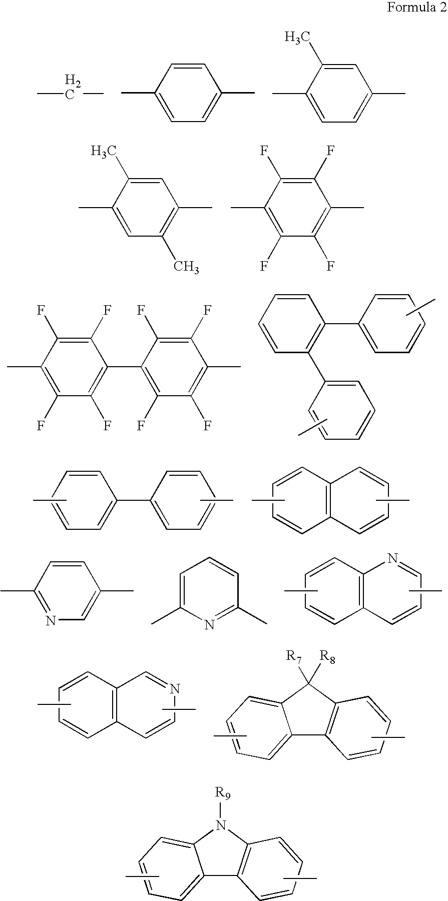

wherein R₇ through R₉ are selected from the same compounds as R₁ through R₆ in Formula 1 (described below), and at least two adjacent groups of R₇, R₈, and R₉, if present, may be bound to each other or fused with each other to form a saturated or unsaturated carbon ring.

In Formula 1, R₁, R₂, R₃, R₄, R₅, and R₆ may be each independently a hydrogen atom, a hydroxyl group, a cyano group, a substituted or unsubstituted C₁-C₃₀ alkyl group, a substituted or unsubstituted C₁-C₃₀ alkoxy group, a substituted or unsubstituted C₆-C₃₀ aryl group, a substituted or unsubstituted C₆-C₃₀ aryloxy group, a substituted or unsubstituted C₂-C₃₀ heteroaryl group, or a group represented by —N(Z₁)(Z₂), where Z₁ and Z₂ are each independently hydrogen, a C₁-C₃₀ alkyl group, a C₁-C₃₀ alkoxy group, or a C₆-C₃₀ aryl group. At least two adjacent groups of R₁, R₂, R₃, R₄, R₅, and R₆ may be bound to each other or fused with each other to form a substituted or unsubstituted carbon ring.

Preferably, R₁, R₂, R₃, R₄, R₅, and R₆ may be each independently a hydrogen atom, a hydroxyl group, a cyano group, a substituted or unsubstituted C₁-C₁₀ alkyl group, a substituted or unsubstituted C₆-C₁₂ aryl group, a substituted or unsubstituted C₂-C₁₂ heteroaryl group, or a group represented by —N(Z₁)(Z₂), where Z₁ and Z₂ are each independently hydrogen, a C₁-C₃₀ alkyl group, a C₁-C₃₀ alkoxy group, or a C₆-C₃₀ aryl group.

More particularly, R₁ through R₆ may each independently comprise one of a plurality of structures represented by Formula 3 below, but R₁ through R₆ are not limited thereto:

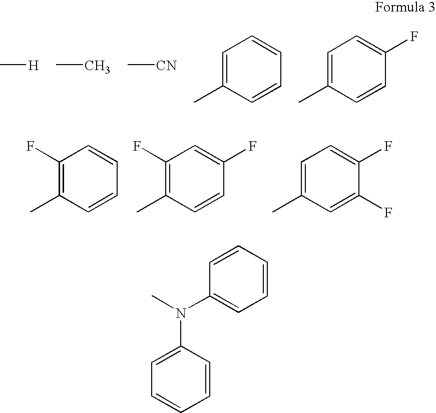

wherein R₇ through R₉ may also be independently represented by one of the structures represented by Formula 3 above.

In Formula 1, each of n₁, n₂, n₃, n₄, and n₅ is independently an integer of 0-5, provided that n₁, n₂, n₃, n₄, and n₅ are not all 0. That is, a compound represented by Formula 1 contains at least one fluorine. More particularly, n₂ and n₃ may independently be 1 or 2. In addition, n₄ and n₅ may independently be 1, 2 or 3.

Hereinafter, the definition of representative groups of the groups used in the formulae according to aspects of the present invention will be described. Of the above formulae, examples of the unsubstituted C₁-C₃₀ alkyl group may include methyl, ethyl, propyl, isobutyl, sec-butyl, pentyl, iso-amyl, hexyl, and the like. At least one hydrogen atom of these alkyl groups may be substituted with a substituent such as a halogen atom, a substituted or unsubstituted C₆-C₁₂ aryl group, a substituted or unsubstituted C₁-C₃₀ alkyl group, a substituted or unsubstituted C₁-C₃₀ alkoxy group, a low-level alkylamino group, a hydroxyl group, a nitro group, a cyano group, an amino group, an amidino group, hydrazine, hydrazone, a carboxyl group, a sulfonic acid group, a phosphoric acid group, or the like.

Of the above formulae, examples of the unsubstituted C₁-C₃₀ alkoxy group may include methoxy, ethoxy, propoxy, isobutyloxy, sec-butyloxy, pentyloxy, pentyloxy, iso-amyloxy, hexyloxy, and the like. At least one hydrogen atom of these alkoxy groups may be substituted with one of the same substituents as listed with respect to the unsubstituted C₁-C₃₀ alkyl group described above; however, if one of the hydrogen atoms is substituted, the substitution may be but need not be a substitution of the same substituent. Further, if multiple hydrogen atoms are substituted, such multiple substitutions may be but need not be substations of the same substituents.

Of the above formulae, the C₆-C₃₀ aryl group refers to a carbocyclic aromatic system containing at least one ring. The at least one aromatic ring may be attached to each other by a pendant method or fused with each other. The term “aryl” includes an aromatic system such as phenyl, naphthyl, anthracenyl. In addition, at least one hydrogen atom of the aryl group may be substituted with one of the same substituents as listed with respect to the unsubstituted C₁-C₃₀ alkyl group described above; however, if one of the hydrogen atoms is substituted, the substitution may be but need not be a substitution of the same substituent. Further, if multiple hydrogen atoms are substituted, such multiple substitutions may be but need not be substations of the same substituents.

Of the above formulae, the C₂-C₃₀ heteroaryl group may be a monovalent monocyclic ring compound containing 2 through 30 ring atoms, which comprises 1, 2 or 3 hetero atoms selected from N, O, P and S and in which the remaining ring atom is C. Herein, the rings may be attached to each other by a pendant method or fused with each other. Examples of the heteroaryl group include pyridyl, thienyl, furil and the like. In addition, at least one hydrogen atom of the heteroaryl groups may be substituted with one of the same substituents as listed with respect to the unsubstituted C₁-C₃₀ alkyl group described above; however, if one of the hydrogen atoms is substituted, the substitution may be but need not be a substitution of the same substituent. Further, if multiple hydrogen atoms are substituted, such multiple substitutions may be but need not be substations of the same substituents.

Of the above formulae, the C₆-C₃₀ aryloxy group refers to a group represented by —OA₁ where A₁ may be the C₆-C₃₀ aryl group described above. The aryloxy group may be a phenoxy group or the like. At least one hydrogen atom of the aryloxy groups may be substituted with one of the same substituent as listed with respect to the unsubstituted C₁-C₃₀ alkyl group described above; however, if one of the hydrogen atoms is substituted, the substitution may be but need not be a substitution of the same substituent. Further, if multiple hydrogen atoms are substituted, such multiple substitutions may be but need not be substations of the same substituents.

The C₆-C₃₀ arylene group of the above formulae refers to a bivalent carbocyclic aromatic system containing at least one ring, and the rings may be attached to each other by a pendant method or fused with each other. Examples of the C₆-C₃₀ arylene group include a phenylene group, a naphthalene group, and the like. At least one hydrogen atom of the arylene group may be substituted with the same substituent as in the case of the unsubstituted C₁-C₃₀ alkyl group described above; however, if one of the hydrogen atoms is substituted, the substitution may be but need not be a substitution of the same substituent. Further, if multiple hydrogen atoms are substituted, such multiple substitutions may be but need not be substations of the same substituents.

The C₂-C₃₀ heteroarylene group of the above formulae refers to a bivalent monocyclic ring compound having 2-30 carbon atoms and containing one, two or three hetero atoms selected from N, O, P, and S, or a compound in which the rings are attached to each other by a pendant method or fused with each other. The C₂-C₃₀ heteroarylene group may be carbazolylene, or the like. At least one hydrogen atom of the heteroarylene group may be substituted with the same substituent as in the case of the unsubstituted C₁-C₃₀ alkyl group described above; however, if one of the hydrogen atoms is substituted, the substitution may be but need not be a substitution of the same substituent. Further, if multiple hydrogen atoms are substituted, such multiple substitutions may be but need not be substations of the same substituents.

Examples of the unsubstituted C₁-C₃₀ alkylene group of the above formulae include methylene, ethylene, propylene, and the like. At least one hydrogen atom of the alkylene group may be substituted with the same substituent as in the case of the unsubstituted C₁-C₃₀ alkyl group described above; however, if one of the hydrogen atoms is substituted, the substitution may be but need not be a substitution of the same substituent. Further, if multiple hydrogen atoms are substituted, such multiple substitutions may be but need not be substations of the same substituents.

In particular, the compound of Formula 1 may be one of a plurality of compounds represented by Compounds 1 through 85 below:

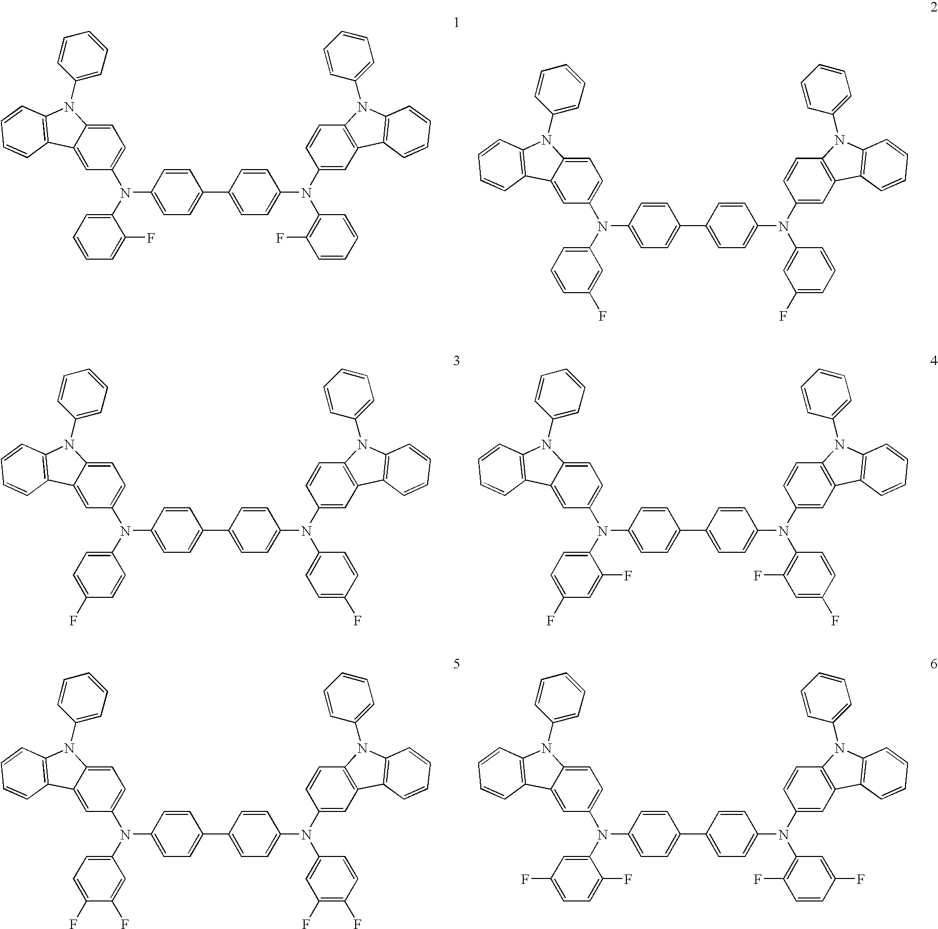

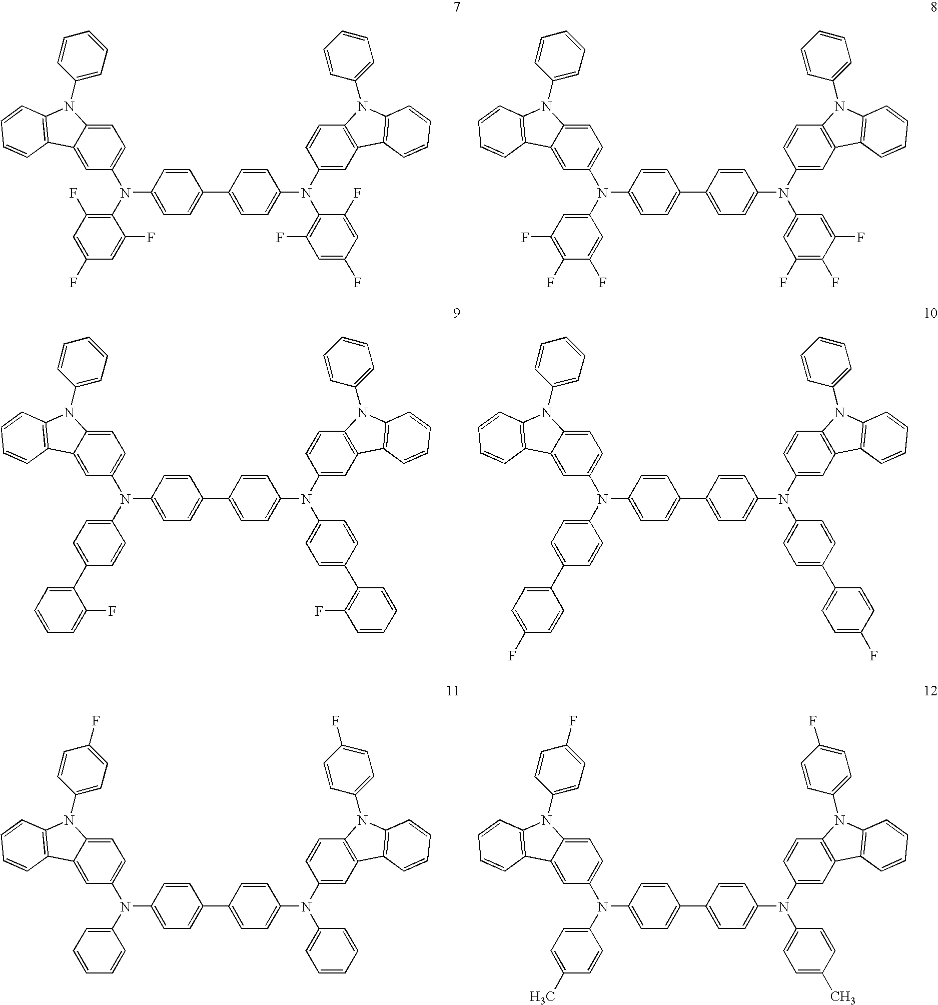

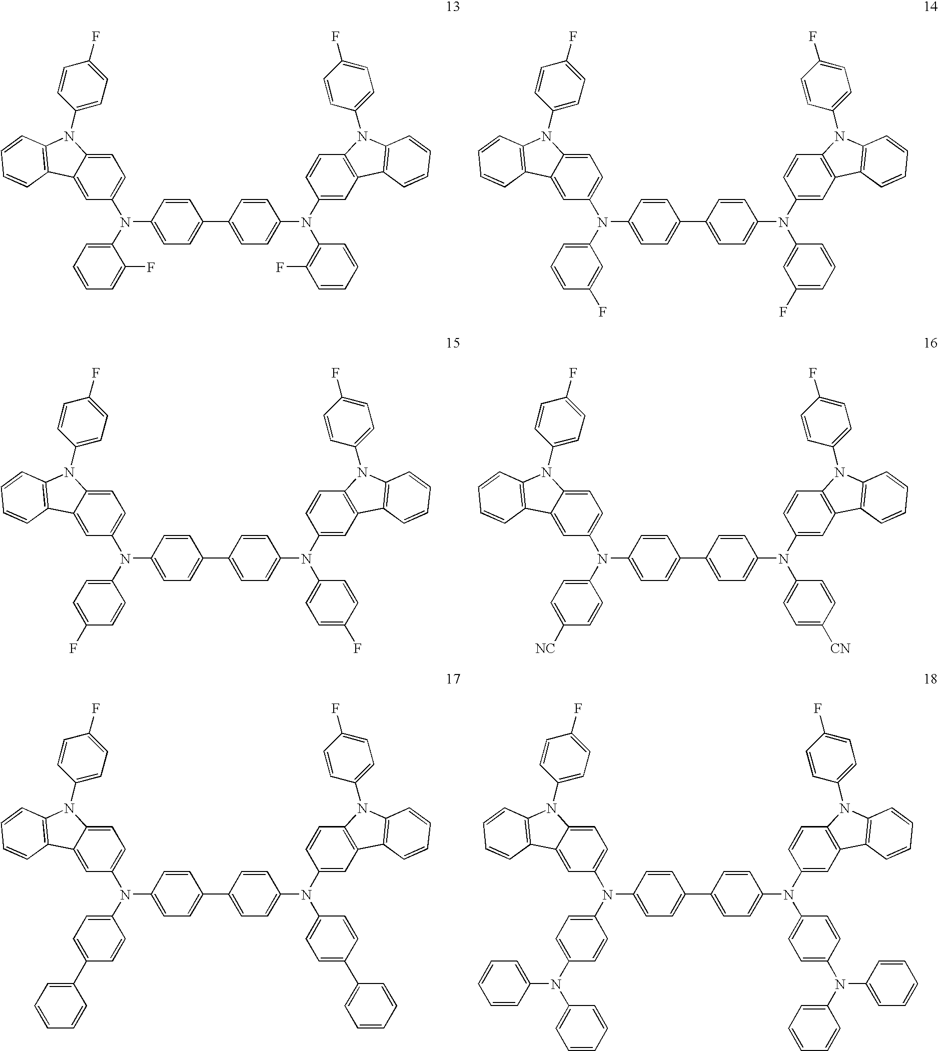

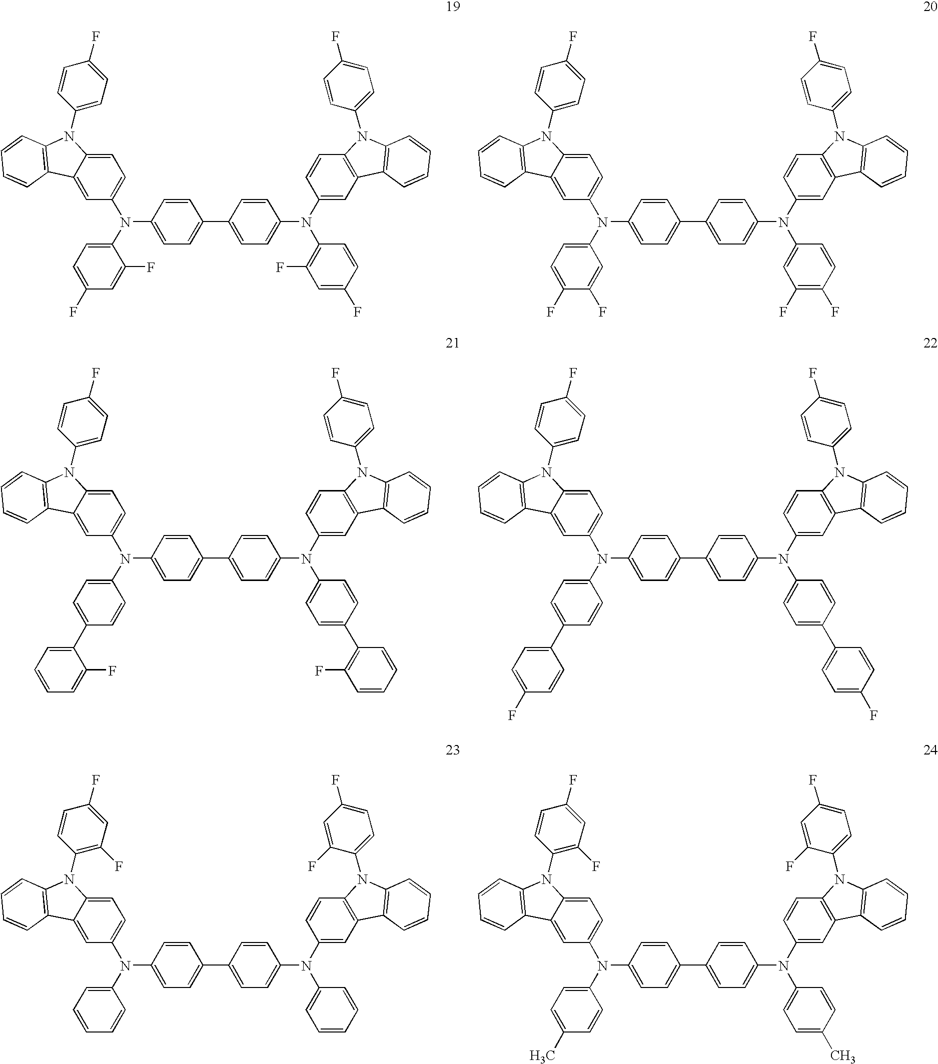

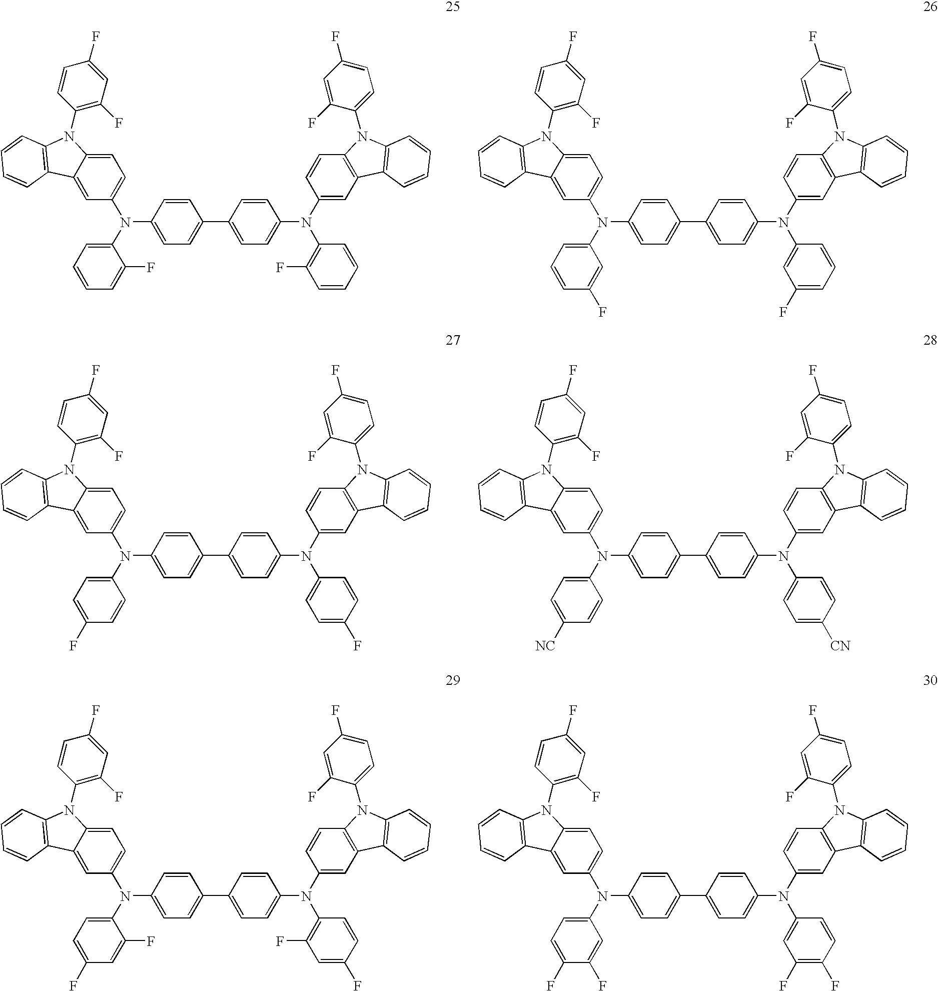

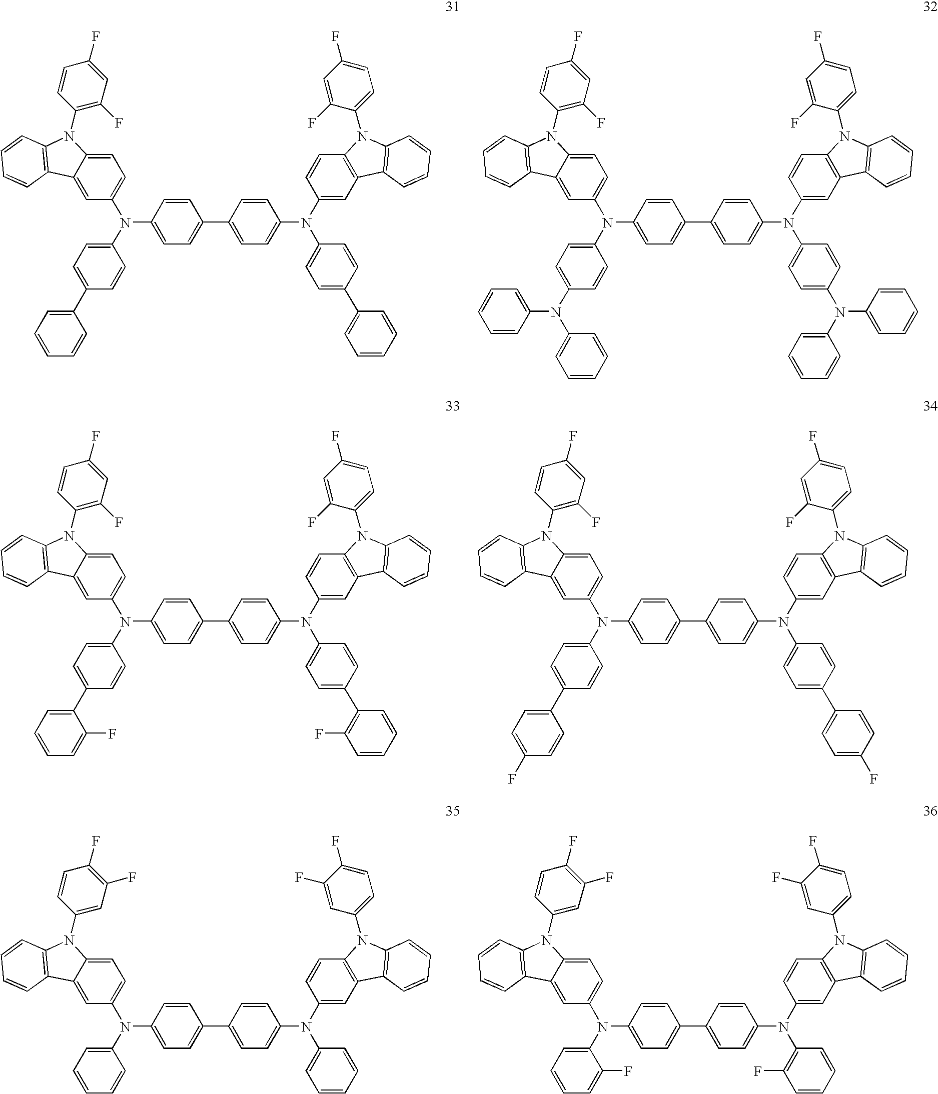

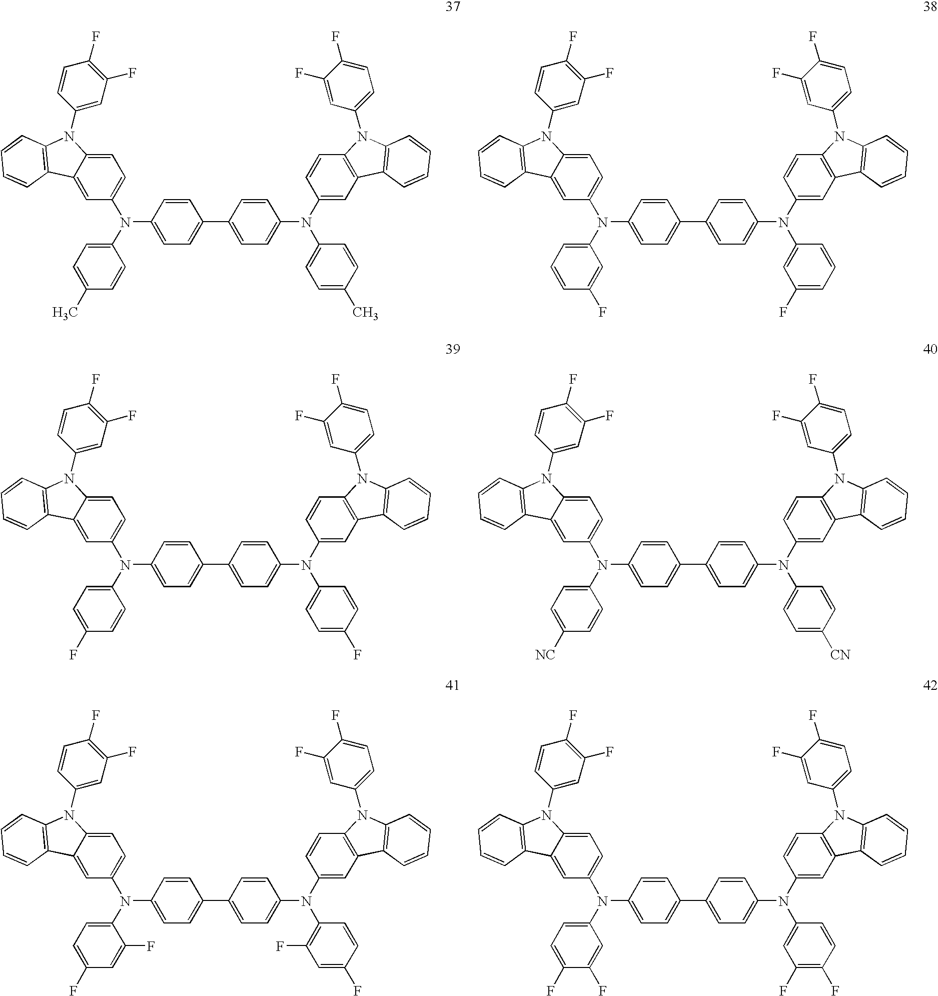

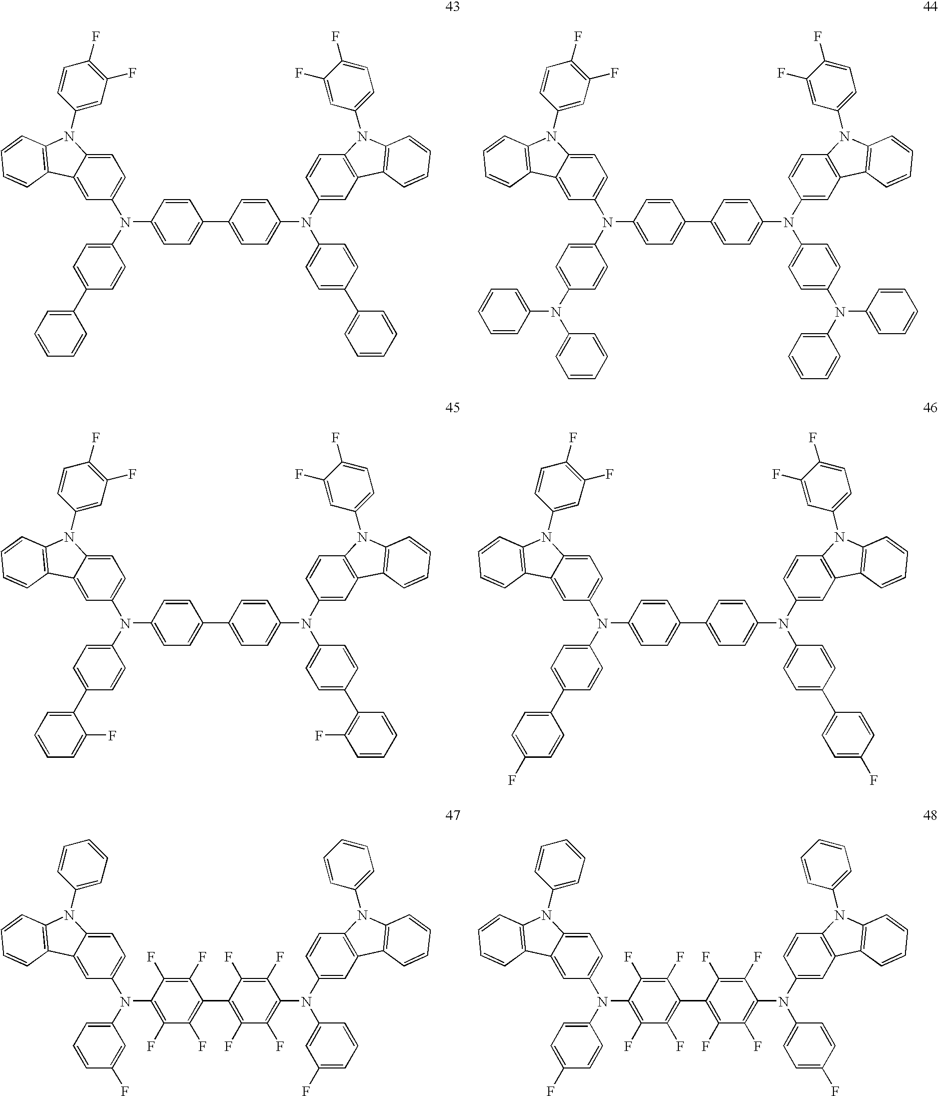

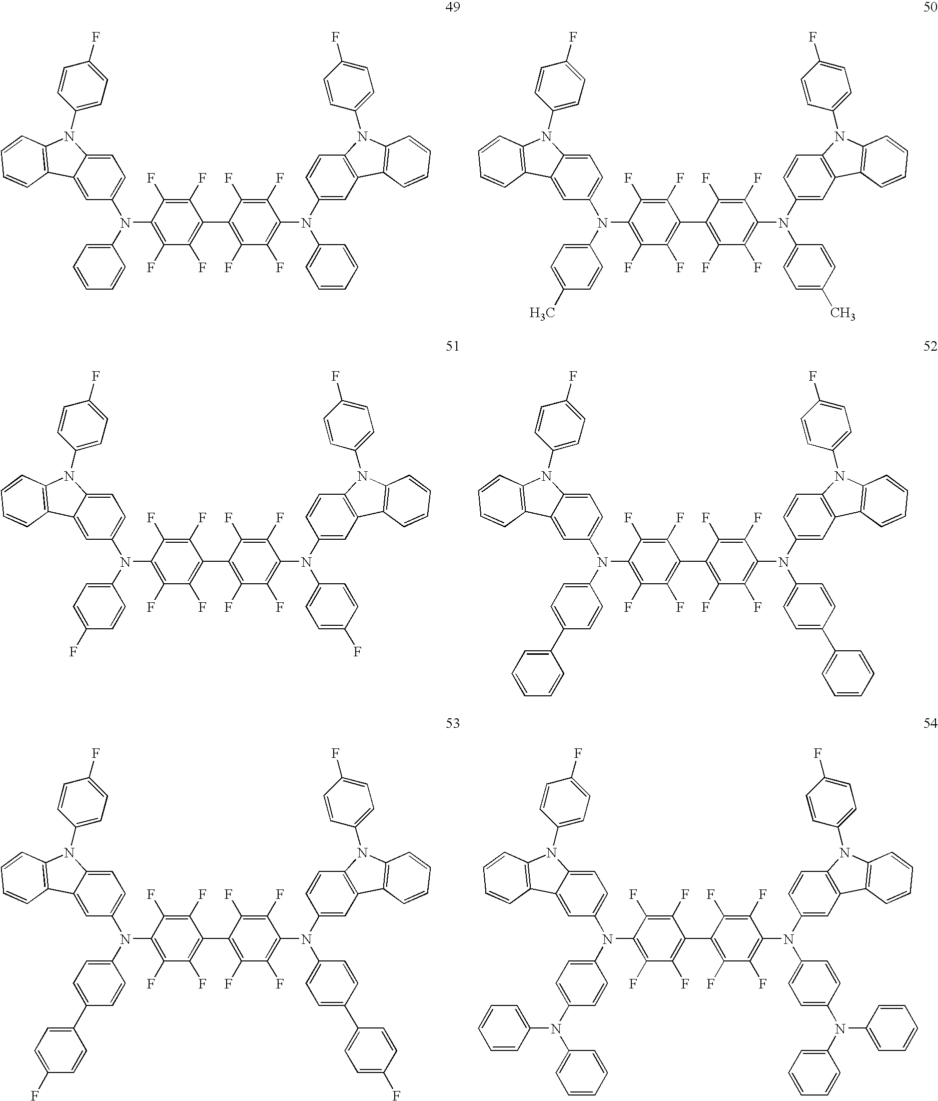

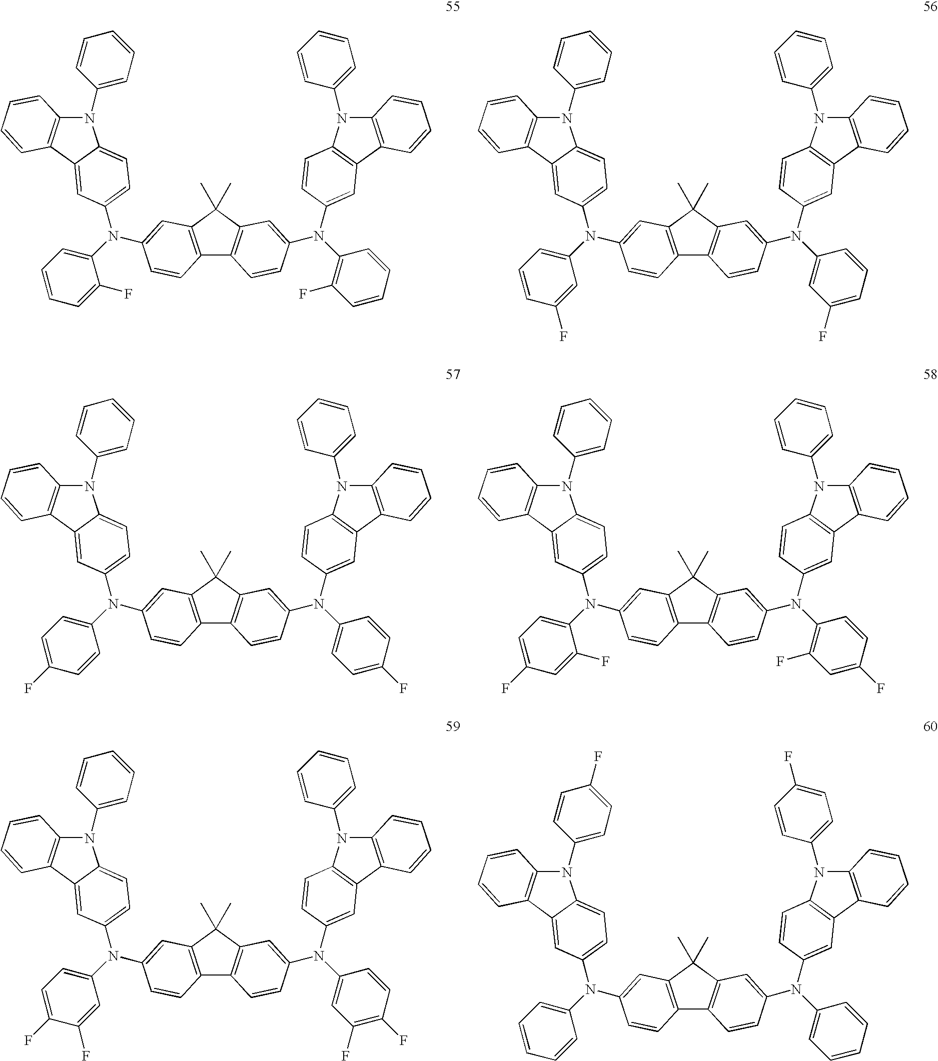

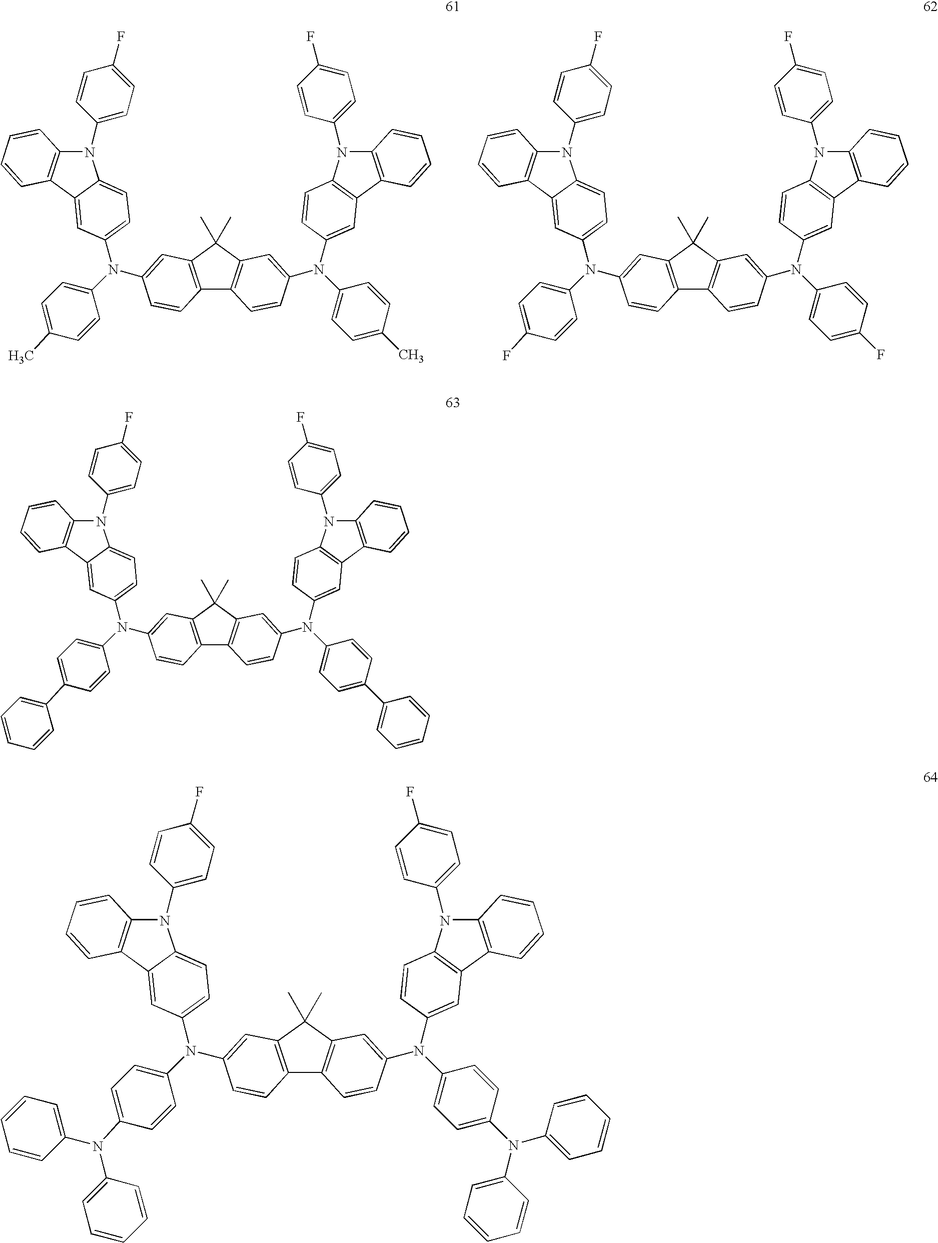

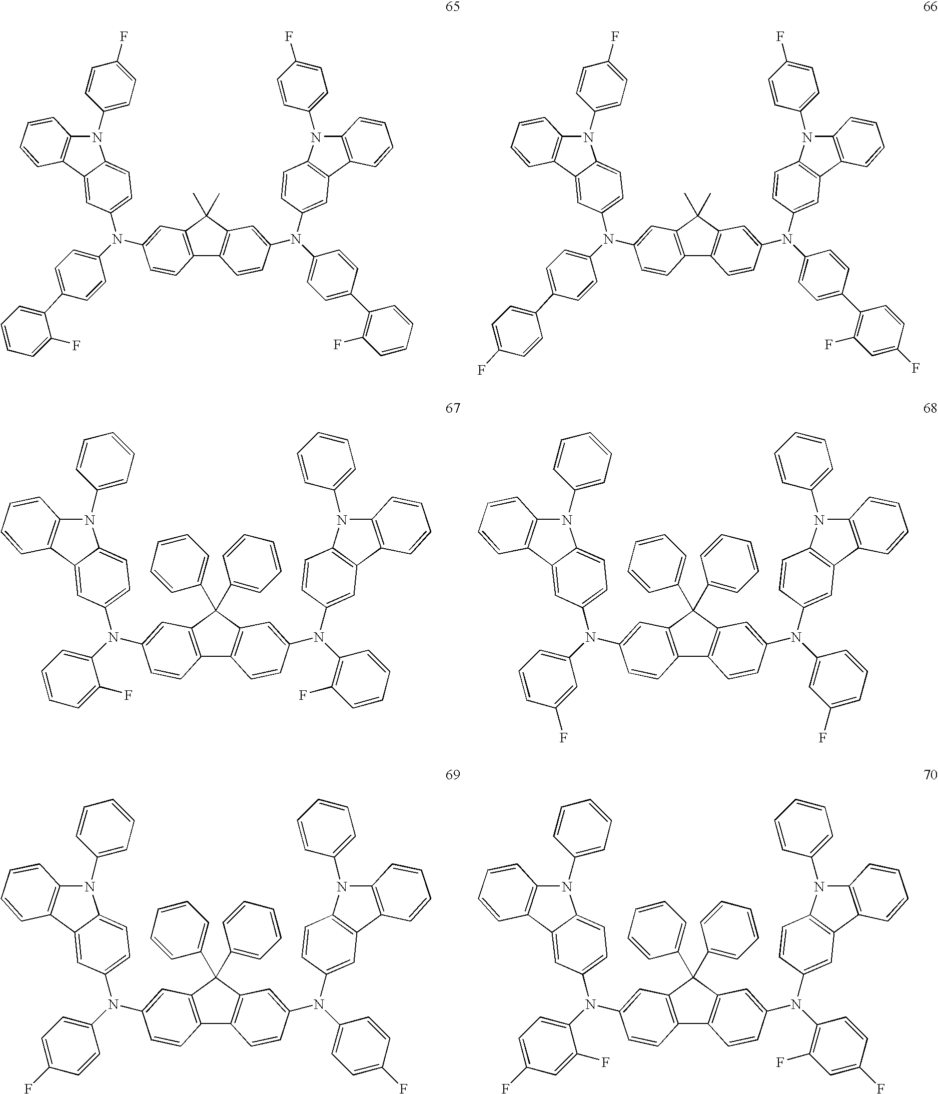

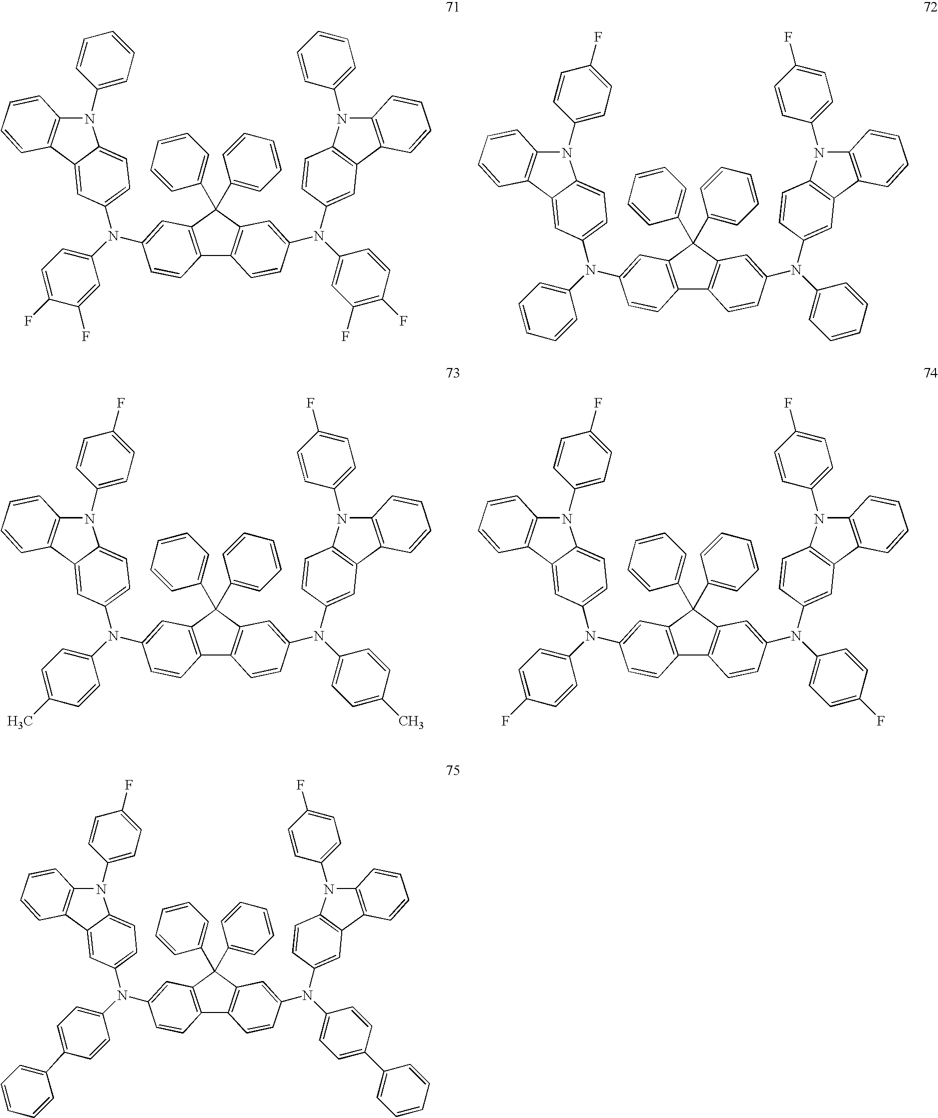

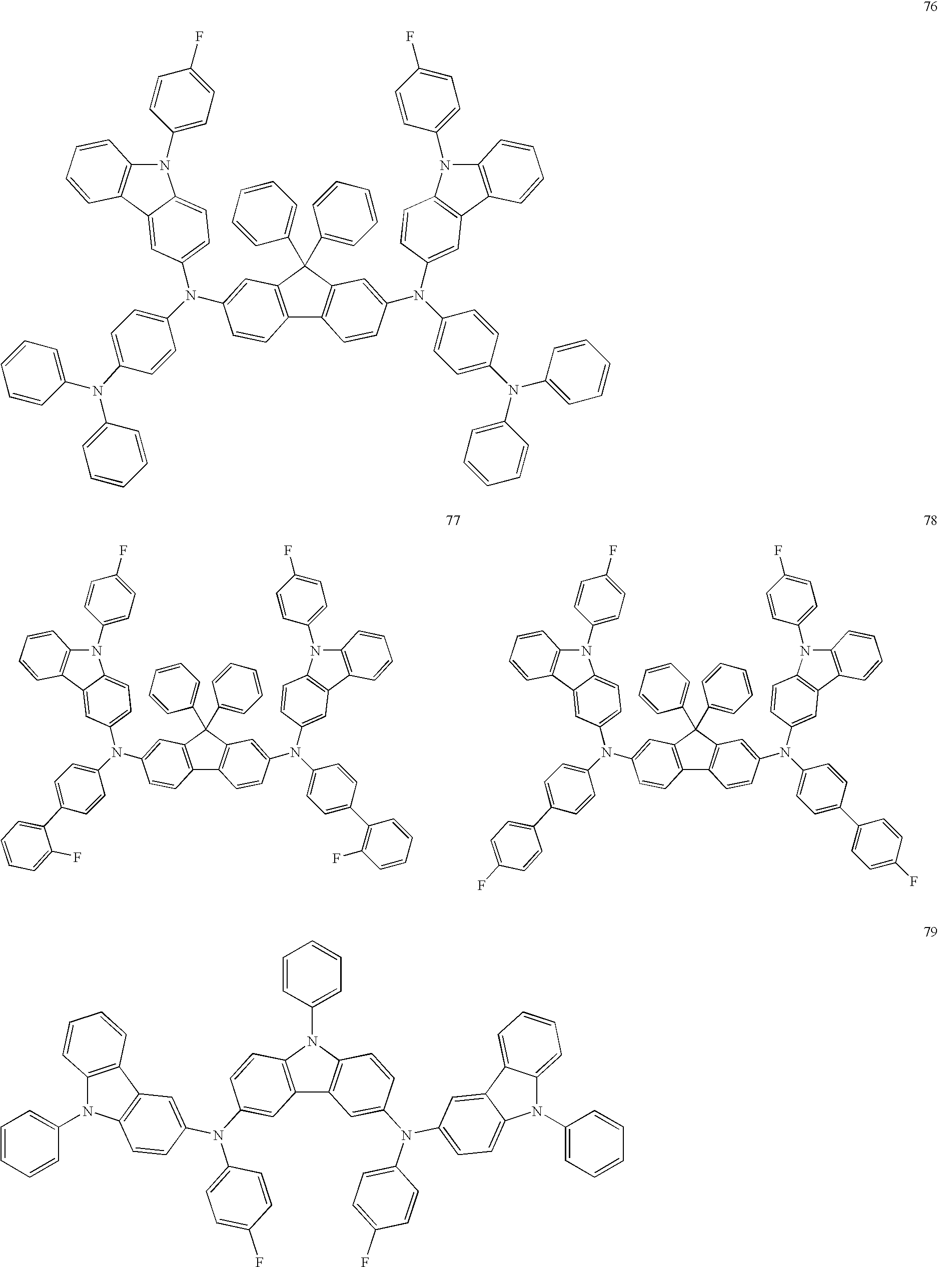

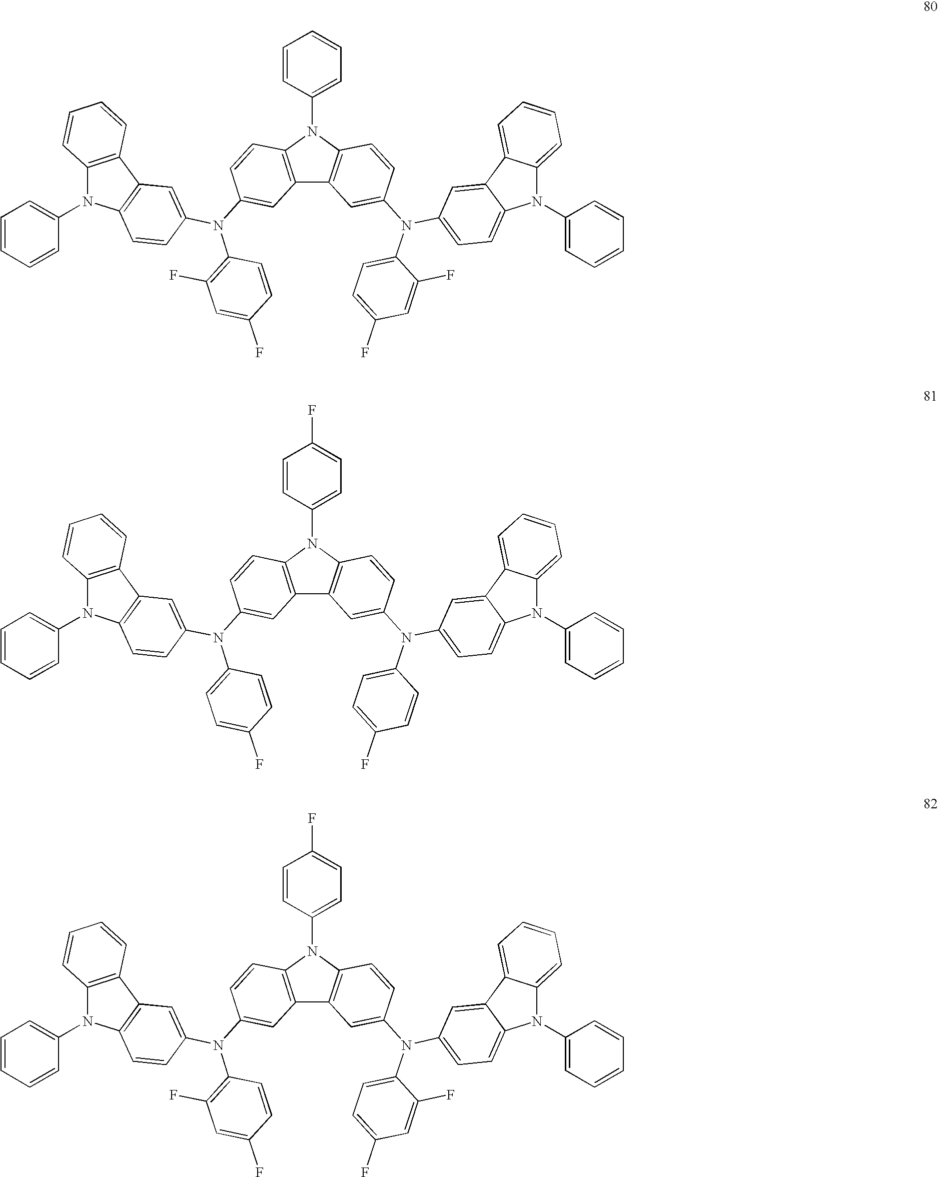

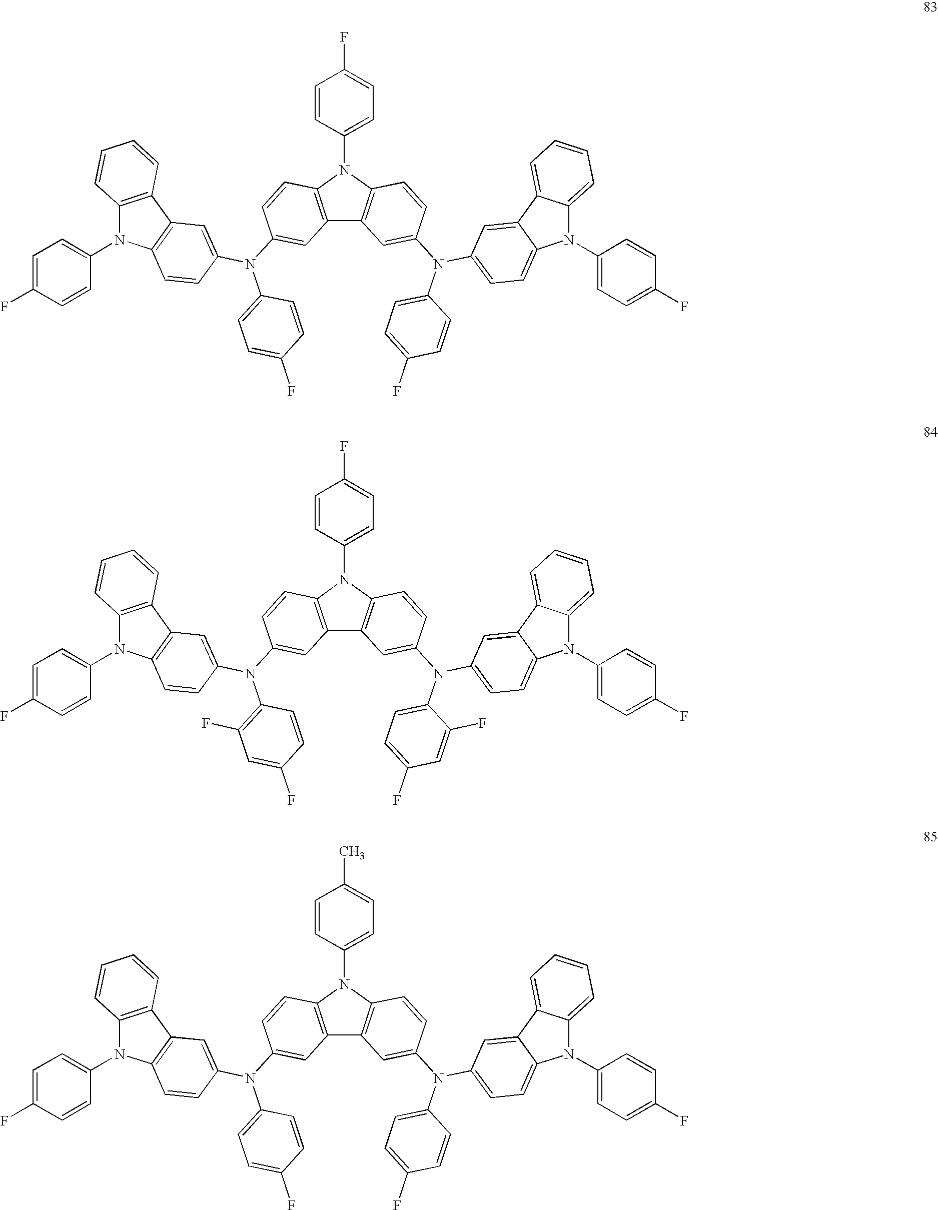

According to an embodiment of the present invention, the compound of Formula 1 may be one of the Compounds 3, 11, 12, 15, and 49.

The compound of Formula 1 may be prepared using an organic synthesis reaction. For example, when n₂=n₃, R₄=R₁, R₅=R₂, the compound of Formula 1 may be obtained by reacting phenylcarbazole (B′) and a diamine compound (C′) as in Reaction Scheme 1:

Reaction Scheme 1

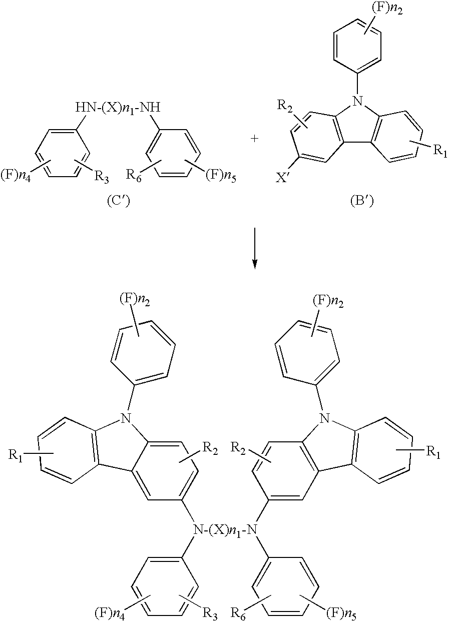

wherein a detailed description of X, R₁, R₂, R₃, R₆, n₁, n₂, n₄, and n₅ has been provided above. In Reaction Scheme 1, X′ refers to a halogen atom. The reaction is performed in the presence of Pd₂(dba)₃ in which (dba=dibenzylideneacetone), sodium tertbutoxide and tri(tertbutyl)phosphine, and a reaction temperature may be 50° C. to 150° C.

Since the compound of Formula 1 contains a fluorine group that can trap electrons, the hole transport layer (HTL), the first hole injection layer (HIL 1), and the second hole injection layer (HIL 2) according to aspects of the present invention are protected from electron collisions so as to be stabilized. Thus, an organic light emitting diode with a relatively long life-time can be obtained.

In addition, the compound of Formula 1 containing fluorine has a high glass transition temperature (Tg). Therefore, when an organic light emitting diode operates, heat resistance to heat generated in the organic layer (OL), between organic layers of the organic layer (OL) or between the organic layer (OL) and the metal electrodes is decreased thereby resulting in excellent durability in a high temperature environment.

According to an embodiment of the present invention, both the first hole injection layer (HIL 1) and the second hole injection layer (HIL 2) of the organic layer (OL) of the organic light emitting diode may comprise a compound represented by Formula 1. When both the first hole injection layer (HIL 1) and the second hole injection layer (HIL 2) of the organic layer (OL) of the organic light emitting diode comprise a compound represented by Formula 1, the first hole injection layer (HIL 1) and the second hole injection layer (HIL 2) of the organic layer (OL) need not be formed of the same compound represented by Formula 1.

According to another embodiment of the present invention, either the first hole injection layer (HIL 1) or the second hole injection layer (HIL 2) of the organic layer of the organic light emitting diode may comprise the compound of Formula 1.

The loss of a hole transporting ability of the hole transport layer (HTL) due to electrons from the emissive layer colliding with the hole transport layer (HTL) is decreased, and accordingly, life-time of the organic light emitting diode can be significantly increased using the compound of Formula 1 containing a fluorine group in at least one of the first hole injection layer (HIL 1) and the second hole injection layer (HIL 2). In particular, when the first hole injection layer (HIL 1) and the second hole injection layer (HIL 2) are disposed in this order from the substrate, the second hole injection layer (HIL 2) may comprise the compound of Formula 1.

In addition, the first electrode and the second electrode may be each independently a reflective electrode, a semi-transparent electrode, or a transparent electrode. Herein, in order to generate resonance between the first electrode and the second electrode during the operation of the organic light emitting diode, one of the first electrode and the second electrode may be a reflective electrode and the other may be a semi-transparent electrode or a transparent electrode. Also, when both the first electrode and the second electrode are transparent or semi-transparent electrodes, a metal reflective layer may be formed on an external surface of the first electrode or the second electrode. Thus, when the organic light emitting diode operates, light generated in the organic layer (OL) disposed between the first electrode and the second electrode resonates between the first electrode and the second electrode to be emitted from the organic light emitting diode through the first electrode or the second electrode. However, aspects of the present invention are not limited thereto such that light may be simultaneously emitted from the organic light emitting diode through both the first electrode and the second electrode.

The combined thickness of the first hole injection layer (HIL 1) and second hole injection layer (HIL 2) when light generated in the organic layer is emitted through the second electrode, i.e., when light generated in the emissive layer (EML) is emitted through the electron transport layer (ETL), the electron injection layer (EIL), and other included layers, and out of the organic light emitting diode through the second electrode, will now be described.

When the light generated in the organic layer (OL) is emitted through the second electrode, the combined thickness of the first hole injection layer (HIL 1) and the second hole injection layer (HIL 2) may be 50-2000 Å, preferably 100-1000 Å. When the combined thickness of the first hole injection layer (HIL 1) and the second hole injection layer (HIL 2) is within the ranges described above, a hole injecting property appropriate to a resonance effect can be obtained, and thus the organic light emitting diode can have excellent color purity and efficiency. In addition, when one of the first hole injection layer (HIL 1) and the second hole injection layer (HIL 2) comprises the compound of Formula 1, the thickness of the layer comprising the compound of Formula 1 may be 50% or less of the combined thickness of the first hole injection layer (HIL 1) and the second hole injection layer (HIL 2), preferably 10-50%, but is not limited thereto such that the thickness of the layer comprising the compound of Formula 1 may be greater than 50% of the combined thickness of the first hole injection layer (HIL 1) and the second hole injection layer (HIL 2). When the thickness of the layer comprising the compound of Formula 1 is within the ranges described above, electrons from the emissive layer can be effectively trapped.

The combined thickness of the first hole injection layer (HIL 1) and second hole injection layer (HIL 2) when the light generated in the organic layer (OL) is emitted through the first electrode, i.e., when light generated in the emissive layer (EML) is emitted through the hole transport layer (HTL), the first hole injection layer (HIL 1), the second hole injection layer (HIL 2), and other included layers and out of the organic light emitting diode through the first electrode, will now be described.

When the light generated in the organic layer (OL) is emitted through the first electrode, the combined thickness of the first hole injection layer (HIL 1) and the second hole injection (HIL 2) layer may be 50-800 Å, preferably 100-400 Å. When the combined thickness of the first hole injection layer (HIL 1) and the second hole injection layer (HIL 2) is within the ranges described above, a hole injecting property appropriate to a resonance effect can be obtained, and thus the organic light emitting diode can have excellent color purity and efficiency. In addition, when one of the first hole injection layer (HIL 1) and the second hole injection layer (HIL 2) comprises the compound of Formula 1, the thickness of the layer comprising the compound of Formula 1 may be 50% or less of the combined thickness of the first hole injection layer (HIL 1) and the second hole injection layer (HIL 2), preferably 10-50%, but is not limited thereto such that the thickness of the layer comprising the compound of Formula 1 may be greater than 50% of the combined thickness of the first hole injection layer (HIL 1) and the second hole injection layer (HIL 2). When the thickness of the layer comprising the compound of Formula 1 is within the ranges described above, electrons from the emissive layer can be effectively trapped.

The organic light emitting diode according to aspects of the present invention which comprises at least one of the first hole injection layer (HIL 1) and the second hole injection layer (HIL 2) of the organic layer (OL) comprising the compound of Formula 1 between the first electrode and the second electrode has a long life-time. In addition, when the combined thickness of the first hole injection layer (HIL 1) and the second hole injection layer (HIL 2) is within the thickness ranges described above, the resonance effect between the first electrode and the second electrode is optimized. Accordingly, the organic light emitting diode can have excellent turn-on voltage, high current density, high brightness, high color purity, excellent light emitting efficiency, and the like.

With reference again to FIG. 1, the organic layer of the organic light emitting diode according to aspects of the present invention includes the emissive layer (EML), the first hole injection layer (HIL 1) and the second hole injection layer (HIL 2). In addition to the emissive layer, the first hole injection layer (HIL 1), and the second hole injection layer (HIL 2), the organic layer (OL) may further include at least one of a hole transport layer (HTL), an electron blocking layer (not shown), a hole blocking layer (not shown), an electron transport layer (ETL), and an electron injection layer (EIL). Therefore, for example, the organic light emitting diode may have a substrate/first electrode/first hole injection layer (HIL 1)/second hole injection layer (HIL 2)/hole transport layer (HTL)/emissive layer (EML)/electron transport layer (ETL)/electron injection layer (EIL)/second electrode structure, as illustrated in FIG. 1; however the organic light emitting diode is not limited thereto. For example, the organic light emitting diode may have a substrate/first electrode/first hole injection layer (HIL 1)/second hole injection layer (HIL 2)/hole transport layer (HTL)/electron blocking layer/emissive layer (EML)/hole blocking layer/electron transport layer (ETL)/electron injection layer (EIL)/second electrode structure.

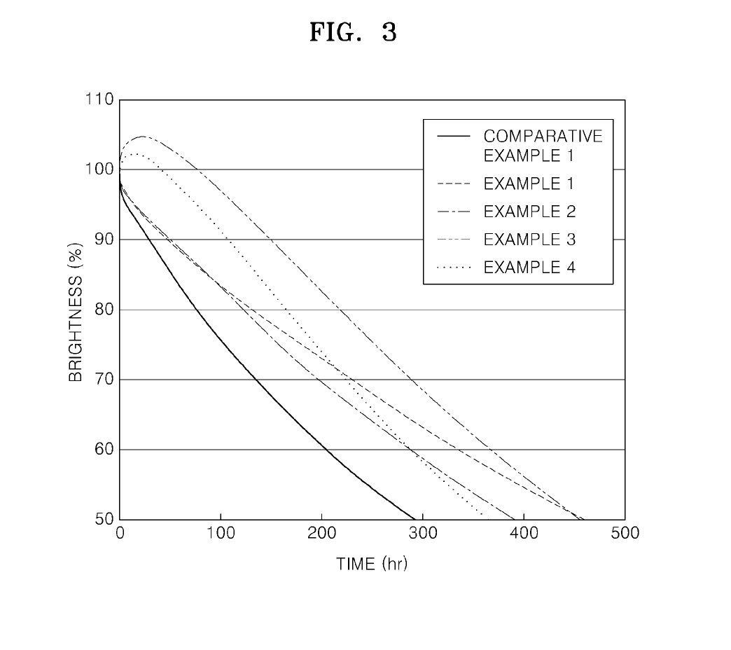

Hereinafter, examples of an organic light emitting diode according to aspects of the present invention and a method of manufacturing the same will be described with reference to FIGS. 1 and 2.

FIG. 1, as described above, is a schematic sectional view illustrating a structure of an organic light emitting diode according to an embodiment of the present invention. FIG. 2 is a schematic sectional view illustrating an organic light emitting diode including red, green, and blue emissive layers, according to an embodiment of the present invention.

Referring to FIG. 2, first, first electrodes 210 are formed on a substrate 200. The substrate 200, which may be any substrate that is used in conventional organic light emitting devices, may be a glass substrate or a transparent plastic substrate that has excellent transparency, surface smoothness, is easily treated, and is waterproof.

The first electrodes 210 may be formed of a highly conductive metal, for example, Li, Mg, Al, Al—Li, Ca, Mg—In, Mg—Ag, Ca—Al, or the like, or metal oxides such as ITO, IZO, IN₂O₃, or the like, and may be reflective electrodes, semi-transparent electrodes, or transparent electrodes. In addition, combinations of the metal and metal oxide may be used.

Next, pixel defining layers 214 that define an organic layer forming region are formed in predetermined positions of the substrate 200. The pixel defining layers 214 may be formed of inorganic materials, such as at least one of silicon oxide and nitride, or formed of an insulating organic material formed in by one of various methods, such as deposition, coating, or the like. As shown in FIG. 2, the pixel defining layers 214 may be formed to a height from the substrate 200 greater than the first electrodes 210 to form a corrugated structure; however aspects of the present invention are not limited thereto such that the pixel defining layers 214 may be formed to a same height as or a height less than the first electrode layers 210.

Next, a first hole injection layer 215, a second hole injection layer 216, and a hole transport layer 218 are sequentially formed on the first electrodes 210 along the regions defined as the pixel defining layers 214 using vacuum thermal deposition or spin coating. The first hole injection layer 215, the second hole injection layer 216, and the hole transport layer 218 may be formed to follow the structure as defined by the first electrodes 210 and the pixel defining layers 214 but aspects of the present invention are not limited thereto.

Herein, the second hole injection layer 216 comprises the compound of Formula 1 as described above, and the first hole injection layer 215 may comprise a known hole injecting material. However, aspects of the present invention are not limited thereto, and each of the second hole injection layer 216 and the first hole injection layer 215 may comprise the compound of Formula 1, or only the first hole injection layer 215 may comprise the compound of Formula 1. Examples of the known hole injecting material may include IDE406 (Idemitsu Co.), a phthalocyanine compound, such as copper phthalocyanine disclosed in U.S. Pat. No. 4,356,429; a star-burst type amine derivative, such as TCTA (shown below), m-MTDATA (shown below), or m-MTDAPB, disclosed in Advanced Material, Vol. 6, p. 677 (1994); a soluble and conductive polymer such as polyaniline/Dodecylbenzenesulfonic acid (PANI/DBSA); poly(3,4-ethylenedioxythiophene)/poly(4-styrenesulfonate) (PEDOT/PSS); polyaniline/camphor sulfonic acid (Pani/CSA); (polyaniline)/poly(4-styrenesulfonate) (PANI/PSS); and the like, but aspects of the present invention are not limited thereto.

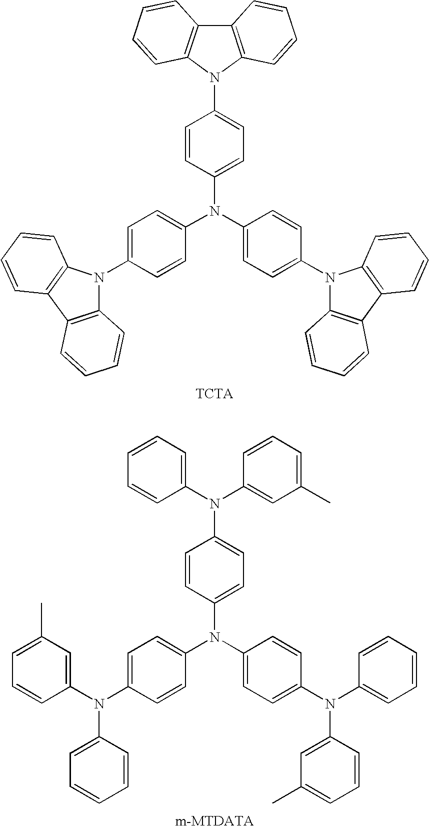

In addition, the hole transport layer 218 may comprise, for example, 1,3,5-tricarbazolylbenzene, 4,4′-biscarbazolylbiphenyl, polyvinylcarbazole, m-biscarbazolylphenyl, 4,4′-biscarbazolyl-2,2′-dimethylphenyl, 4,4′,4″-tri(N-carbazolyl)triphenylamine, 1,3,5-tri(2-carbazolylphenyl)benzene, 1,3,5-tris(2-carbazolyl-5-methoxyphenyl)benzene, bis(4-carbazolylphenyl)silane, N,N′-bis(3-methylphenyl)-N,N′-diphenyl-[1,1-biphenyl]-4,4′diamine (TPD), N,N′-di(naphthalene-1-yl)-N,N′-diphenyl benzidine (α-NPD), N,N′-diphenyl-N,N′-bis(1-naphthyl)-(1,1′-biphenyl)-4,4′-diamine (NPB), poly(9,9-dioctylfluorene-co-N-(4-butylphenyl)diphenylamine (TFB), poly(9,9-dioctylfluorene-co-bis-(4-butylphenyl-bis-N,N-phenyl-1,4-phenylenediamin)) (PFB), or the like, but aspects of the present invention are not limited thereto.

Thicknesses of the first hole injection layer 215 and the second hole injection layer 216 have been described previously with reference to the direction of light emission direction.

The first hole injection layer 215 and the second hole injection layer 216 may be formed using various methods such as vacuum deposition, spin coating, casting, Langmuir Blodgett (LB) deposition, or the like.

When the first and second hole injection layers 215 and 216 are formed by vacuum deposition, deposition conditions may vary according to the compounds that are used to form the first and second hole injection layers 215 and 216, and the desired structure and thermal properties of the first and second hole injection layers 215 and 216 to be formed. In general, however, the vacuum deposition may be performed at a deposition temperature of 100-500° C., a pressure of 10⁻⁸-10⁻³ torr, and a deposition speed of 0.01-100 Å/sec.

When the first and second hole injection layers 215 and 216 are formed by spin coating, coating conditions may vary according to the compound that is used to form the first and second hole injection layers 215 and 216, and the desired structure and thermal properties of the first and second hole injection layers 215 and 216 to be formed. In general, however, the coating speed may be about 2,000-5,000 rpm, and a temperature for heat treatment, which is performed to remove a solvent after coating, may be about 80-200° C.

The hole transport layer 218 may be formed using various methods such as vacuum deposition, spin coating, casting, LB deposition, or the like. When the hole transport layer 218 is formed by vacuum deposition or spin coating, vacuum deposition conditions or coating conditions may vary according to the compound that is used to form the hole transport layer 218. However, in general, the deposition or coating conditions may similar to those of the first and second hole injection layers 215 and 216.

The thickness of the hole transport layer 218 may be 50-1500 Å so as to obtain excellent hole transporting properties and low turn-on voltage.

Next, red, green, and blue emissive layers 220, 225, and 230 to emit red, green, and blue light are formed on the hole transport layer 218. An emissive layer material used to form the red, green, and blue emissive layers 220, 225, and 230 according to aspects of the present invention is not particularly limited.

The red emissive layer 220 may be formed using, for example, Eu(thenoyltrifluoroacetone)₃ (referred to as Eu(TTA)₃), butyl-6-(1,1,7,7,-tetramethyljulolidyl-9-enyl)-4H-pyran (referred to as DCJTB), or the like. In addition, the red emissive layer 220 may be formed using various modifications, for example, doping a dopant such as DCJTB into Alq₃, or co-depositing Alq₃ and rubrene and doping a dopant thereinto, or the like.

The green emissive layer 225 may be formed using, for example, Coumarin 6, C545T, Quinacridone, Ir(ppy)₃, or the like. In addition, the green emissive layer 225 may be formed using various modifications, for example, using Ir(ppy)₃ as a dopant into CBP (manufactured by UDC), or using coumarin-based materials as a dopant into an Alq₃ host. Examples of the coumarin-based dopant, shown below, include C314S, C314T, C545T, and the like.

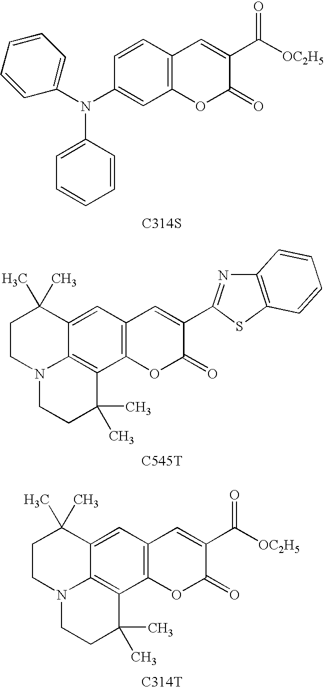

The blue emissive layer 230 may be formed using various materials, for example, oxadiazole dimer dyes (Bis-DAPOXP)), spiro compounds (for example, Spiro-DPVBi, as shown below), triarylamine compounds, CzTT (shown below), Anthracene, TPB (shown below), BBOT (shown below), aromatic hydrocarbon compounds containing a naphthalene moiety and the like such as BH-013X (Idemitsu Co.), or the like. In addition, the blue emissive layer 230 may be formed using various modifications, for example, using IDE118 (Product name, Idemitsu Co.) as a dopant into IDE215 (Product name, Idemitsu Co.), or the like.

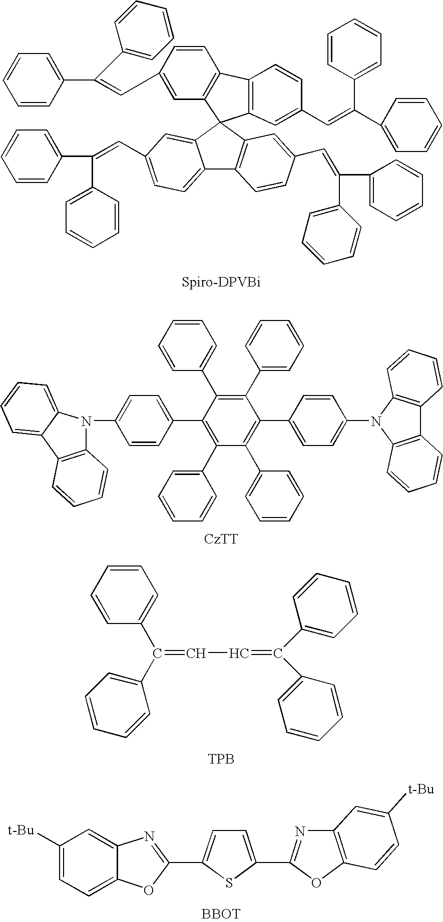

The thicknesses of the red, green, and blue emissive layers 220, 225, and 230 may be 200-500 Å, and preferably, 300-400 Å. Herein, the thickness of each of the red, green, and blue emissive layers 220, 225 and 230 may be the same or different. When the thickness of each of the red, green, and blue emissive layers 220, 225, and 230 is 200 Å or more, the lifetime of the organic light emitting diode can be increased. When the thickness of each of the red, green, and blue emissive layers 220, 225, and 230 is 500 Å or less, a turn-on voltage of the organic light emitting diode can be substantially decreased.

The red, green, and blue emissive layers 220, 225, and 230 may be formed using various methods such as vacuum deposition, spin coating, casting, LB deposition, or the like. When the red, green, and blue emissive layers 220, 225, and 230 are formed by vacuum deposition or spin coating, vacuum deposition conditions or coating conditions may vary according to the compound that is used to form the red, green, and blue emissive layers 220, 225, and 230. However, in general, the deposition and coating conditions may be similar to those used for the formation of the first and second hole injection layers 215 and 216.

A hole blocking layer (not shown) may be selectively formed by vacuum depositing or spin coating a hole blocking material on the red, green, and blue emissive layers 220, 225, and 230. The hole blocking material used herein is not particularly limited, but has to have an electron transporting ability and also have ionization potential higher than that of light emitting compounds. Examples of the hole blocking material include bis(2-methyl-8-quinolato)-(p-phenylphenolato)-aluminum (Balq), bathocuproine (BCP), tris(N-aryl benzimidazole) (TPBI), and the like.

The thickness of the hole blocking layer may be 30-60 Å, and preferably, 40-50 Å. When the thickness of the hole blocking layer is 30 Å or more, hole blocking properties are satisfactorily reproduced. When the thickness of the hole blocking layer is 60 Å or less, a turn-on voltage of the organic light emitting diode is relatively low.

The hole blocking layer may be formed using various methods such as vacuum deposition, spin coating, casting, LB deposition, or the like. When the hole blocking layer is formed by vacuum deposition or spin coating, vacuum deposition conditions or coating conditions may vary according to the compound that is used to form the hole blocking layer. However, in general, the deposition or coating conditions may be similar to those used for the formation of the first and second hole injection layers 215 and 216.

An electron transport layer 240 may be selectively formed by vacuum depositing or spin coating an electron transporting material on the red, green, and blue emissive layers 220, 225, and 230. The electron transporting material is not particularly limited, and may be Alq₃ or the like.

The thickness of the electron transport layer 240 may be 100-400 Å, and preferably, 250-350 Å. When the thickness of the electron transport layer 240 is less than 100 Å, electron transporting speed is excessive, and thus charge balance can be broken. When the thickness of the electron transport layer 240 is greater than 400 Å, a turn-on voltage of the organic light emitting diode can be increased.

The electron transport layer 240 may be formed using various methods such as vacuum deposition, spin coating, casting, LB deposition, or the like. When the electron transport layer 240 is formed by vacuum deposition or spin coating, vacuum deposition conditions or coating conditions may vary according to the compound that is used to form the electron transport layer 240. However, in general, the deposition or coating conditions may be similar to those used for the formation of the first and second hole injection layers 215 and 216.

An electron injection layer 250 may be formed on the red, green, and blue emissive layers 220, 225, and 230 or the electron transport layer 240 using vacuum deposition or spin coating. A material used to form the electron injection layer 250 may be a material such as BaF₂, LiF, NaCl, CsF, Li₂O, BaO, Liq, or the like, but aspects of the present invention are not limited thereto.

The thickness of the electron injection layer 250 may be 2-10 Å, more preferably 2-5 Å, and most preferably 2-4 Å. When the thickness of the electron injection layer 250 is 2 Å or more, it can effectively function as an electron injection layer. When the thickness of the electron injection layer 250 is 10 Å or less, a turn-on voltage of the organic light emitting diode is relatively low.

The electron injection layer 250 may be formed using various methods such as vacuum deposition, spin coating, casting, LB deposition, or the like. When the electron injection layer 250 is formed by vacuum deposition or spin coating, vacuum deposition conditions or coating conditions may vary according to the compound that is used to form the electron injection layer 250. However, in general, the deposition or coating conditions may be similar to those used for the formation of the first and second hole injection layers 215 and 216.

Subsequently, a second electrode 260 is formed by depositing an electrode material on the electron injection layer 250 to complete the manufacture of the organic light emitting diode according to the current embodiment of the present invention.

The material used to form the second electrode 260 may be LiF, a highly conductive transparent metal oxide, such as ITO, IZO, SnO₂, ZnO, or the like. In addition, the second electrode 260 may be formed as a reflective electrode, a semi-transparent electrode, or a transparent electrode by forming a thin film using Li, Mg, Al, Al—Li, Ca, Mg—In, Mg—Ag, Ca—Al, or the like, and combinations thereof. The material used to form the second electrode 260 is not limited to the metals described above or to combinations thereof.

The first electrodes 210 and the second electrode 260 may be an anode and a cathode, respectively, but the opposite case is also possible.

An organic light emitting diode according to aspects of the present invention may be used in various types of flat display devices, for example, passive matrix organic light emitting display devices and active matrix organic light emitting display devices. In particular, in the case of using the organic light emitting diode in an active matrix organic light emitting display device, a first electrode formed on a substrate is a pixel electrode, and is electrically connected to a source electrode or a drain electrode of a thin film transistor. In addition, the organic light emitting diode may be used in flat display devices having double-sided screens.

Hereinafter, exemplary Synthesis Examples of Compounds 3, 11, 12, 15, and 49 and examples of an organic light emitting diode including layers formed using the same will be fully described for illustrative purposes; however, aspects of the present invention are not limited thereto.

### Synthesis Example 1

### Compound 3 (Preparation of 4,4′-bis[(N-(3-(9-phenyl-9H)carbazolyl)-N-(4-fluorophenyl)amino]biphenyl

Compound 3 was synthesized according to Reaction Scheme 2 below.

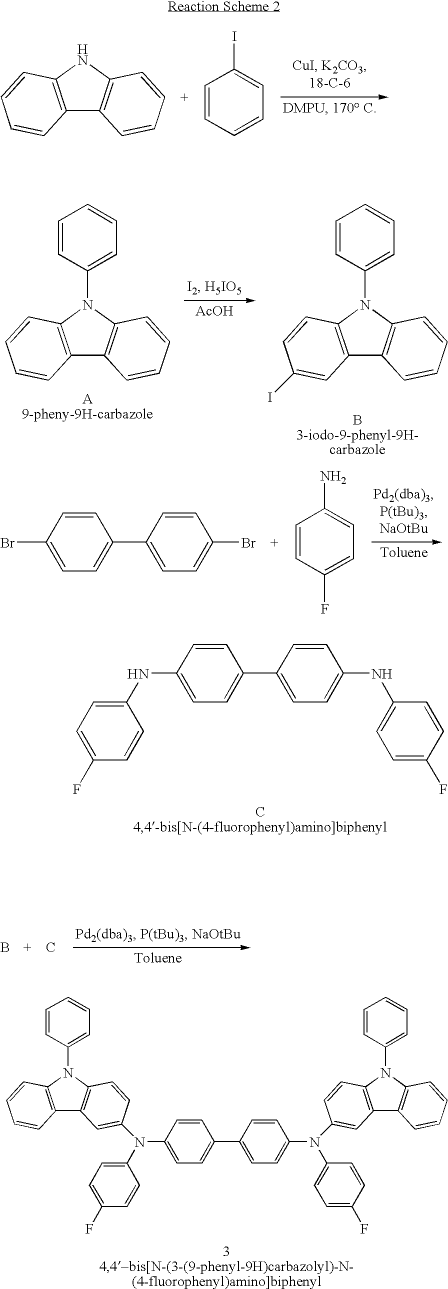

### Synthesis of Intermediate A (9-phenyl-9H-carbazole)

16.7 g of carbazole (100 mmol), 26.5 g of iodobenzene (130 mmol), 1.9 g of CuI (10 mmol), 138 g of K₂CO₃ (1 mol), and 530 mg of 18-crown-6 (2 mmol) were dissolved in 500 ml of 1,3-Dimethyl-3,4,5,6-tetrahydro-(1H)-pyrimidinone (DMPU), and then heated at 170° C. for 8 hours. After the reaction was terminated, a reaction mixture was cooled to room temperature, and then a resulting solid material was filtered. Then, a small amount of ammonia water was added to the filtered water and washed three times using 300 ml of diethylether. The obtained diethylether layer was dried using anhydrous MgSO₄ and then dried under low pressure to obtain a product. The product was purified with silicagel column chromatography to obtain 22 g (yield: 90%) of white solid Intermediate A characterized by ¹H NMR (CDCl₃, 400 MHz) δ (ppm) 8.12 (d, 2H), 7.58-7.53 (m, 4H), 7.46-7.42 (m, 1H), 7.38 (d, 4H), 7.30-7.26 (m, 2H); ¹³C NMR (CDCl₃, 100 MHz) δ (ppm) 141.0, 137.9, 130.0, 127.5, 127.3, 126.0, 123.5, 120.4, 120.0, 109.9.

### Synthesis of Intermediate B (3-iodo-9-phenyl-9H-carbazole)

2.433 g of Intermediate A (9-phenyl-9H-carbazole) (10 mmol) was added to 100 ml of 80% acetic acid. Then, 1.357 g of iodine (I₂) (5.35 mmol) and 0.333 g of ortho-periodic acid (H₅IO₆) (1.46 mmol) in a solid state were added thereto, and stirred under a nitrogen atmosphere at 80° C. for 2 hours. After the reaction was terminated, the resulting product was extracted three times using 50 ml of diethylether. The obtained organic layer was dried with anhydrous MgSO₄. The residue obtained by evaporating a solvent was purified with silicagel column chromatography to obtain 3.23 g (yield: 87%) of white solid Intermediate B characterized by ¹H NMR (CDCl₃, 300 MHz) δ (ppm) 8.43 (d, 1H), 8.05 (d, 1H), 7.62 (dd, 1H), 7.61-7.75 (m, 2H), 7.51-7.43 (m, 3H), 7.41-7.35 (m, 2H), 7.27 (dd, 1H), 7.14 (d, 1H).

### Synthesis of Intermediate C (4,4′-bis[N-(4-fluorophenyl)amino]biphenyl)

3.12 g of 4,4′-dibromobiphenyl (10 mmol), 2.78 g of 4-fluoroanilin (25 mmol), 2.9 g of t-BuONa (30 mmol), 183 mg of Pd₂(dba)₃ (0.2 mmol), and 40 mg of P(t-Bu)₃ (0.2 mmol) were dissolved in 50 ml of toluene and then stirred at 90° C. for 3 hours. The reaction mixture was cooled to room temperature, and then distilled water and diethylether were added thereto. Then, an undissolved solid material was filtered, washed using acetone and diethylether, and dried in vacuum to obtain 2.72 g (yield: 73%) of gray solid Intermediate C characterized by ¹H NMR (C₆D₆, 300 MHz) δ (ppm) 8.05 (s, 2H), 7.68 (d, 2H), 7.48 (d, 4H), 7.29-7.11 (m, 22H), 7.09-7.01 (m, 6H), 6.78 (t, 4H).

### Synthesis of Compound 3 (4,4′-bis[N-(3-(9-phenyl-9H)carbazolyl)-N-(4-fluorophenyl)amino]biphenyl)

8.86 g of Intermediate B (3-iodo-9-phenyl-9H-carbazole) (24.0 mmol), 3.72 g of Intermediate C (4,4′-bis[N-(4-fluorophenyl)amino]biphenyl) (10.0 mmol), 2.88 g of t-BuONa (30.0 mmol), 180 mg of Pd₂(dba)₃ (0.20 mmol), and 40 mg of P(t-Bu)₃ (0.20 mmol) were dissolved in 70 ml of toluene and then stirred at 90° C. for 3 hours. After the reaction was terminated, a reaction mixture was cooled to room temperature and then distilled water was added thereto. Then, the resulting product was extracted three times using 30 ml of diethylether. The obtained organic layer was dried with anhydrous MgSO₄, filtered and then dried under low pressure to obtain a product. The product was purified with silicagel column chromatography to obtain 7.18 g (yield: 84%) of weak yellow solid Compound 3. The obtained Compound 3 was diluted in CHCl₃ to a concentration of 0.2 mM to obtain a UV Spectrum, and maximum absorption wavelengths thereof were observed to be 351, 297, and 248 nm.

In addition, Compound 3 was thermally analyzed using thermo gravimetric analysis (TGA) and differential scanning calorimetry (DSC) (under N₂ atmosphere, temperature range: room temperature ˜600° C. (1° C./min)-TGA, room temperature to 400° C.-DSC, Pan Type: Pt Pan in disposable Al Pan(TGA), disposable Al pan(DSC)) to obtain a decomposition temperature Td of 464° C., a glass transition temperature Tg of 151° C., and a melting temperature Tm of 299° C.

A highest occupied molecular orbital (HOMO) energy level of 5.1 eV and a lowest occupied molecular orbital (LOMO) energy level of 2.28 eV were obtained using AC-2, that is, an UV absorption spectrum and ion potential measuring device.

### Synthesis Example 2

### Preparation of Compound II (4,4′-bis[(N-(3-(9-(4-fluorophenyl)-9H)carbazolyl)-N-phenylamino]biphenyl)

Compound II was synthesized according to Reaction Scheme 3 below.

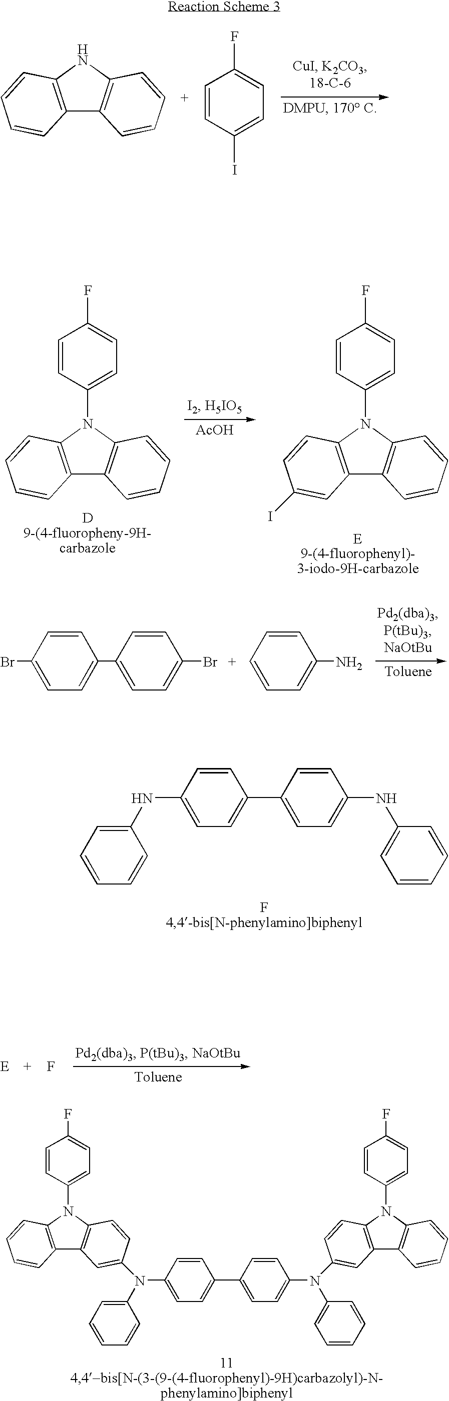

### Synthesis of Intermediate D (9-(4-fluorophenyl)-9H-carbazole)

16.7 g of carbazole (100 mmol), 28.9 g of 4-fluoroiodobenzene (130 mmol), 1.9 g of CuI (10 mmol), 138 g of K₂CO₃ (1.0 mol), and 530 mg of 18-crown-6 (2 mmol) were dissolved in 500 ml of 1,3-Dimethyl-3,4,5,6-tetrahydro-(1H)-pyrimidinone (DMPU), and then stirred at 170° C. for 8 hours. After the reaction was terminated, a reaction mixture was cooled to room temperature, and then a resulting solid material was filtered. Then, a small amount of ammonia water was added to the filtered water and washed three times using 300 ml of diethylether. The obtained diethylether layer was washed using a large amount of distilled water, dried using anhydrous MgSO₄, filtered and then dried under low pressure to obtain a product. The product was purified with silicagel column chromatography to obtain 23.5 g (yield: 90%) of white solid Intermediate D.

### Synthesis of Intermediate E (9-(4-fluorophenyl)-3-iodo-9H-carbazole)

2.61 g of Intermediate D (9-(4-fluorophenyl)-9H-carbazole) was added to 100 ml of 80% acetic acid. Then, 1.357 g of iodine (I₂) (5.35 mmol) and 0.333 g of ortho-periodic acid (H₅IO₆) (1.46 mmol) in a solid state were added to the mixture, and then stirred under a nitrogen atmosphere at 80° C. for 2 hours. After the reaction was terminated, the resulting product was cooled to room temperature. Then, water was added thereto and the resultant was extracted three times using 50 ml of diethylether. The obtained organic layer was washed using 30 ml of an aqueous NaHCO₃ solution and 50 ml of brine in this order, and then dried with anhydrous MgSO₄, filtered and dried under low pressure to obtain a product. The product was purified with silicagel column chromatography to obtain 3.37 g (yield: 87%) of white solid Intermediate E.

### Synthesis of Intermediate F (4,4′-bis[N-phenylamino]biphenyl)

3.12 g of 4,4′-dibromodiphenyl (10 mmol), 2.3 ml of aniline (25 mmol), 2.9 g of t-BuONa (30 mmol), 183 mg of Pd₂(dba)₃ (0.2 mmol), and 40 mg of P(t-Bu)₃ (0.2 mmol) were dissolved in 50 ml of toluene, and then stirred at 90° C. for 3 hours. A reaction mixture was cooled to room temperature, and then distilled water and diethylether were added thereto. Then, an undissolved solid material was filtered, washed using acetone and diethylether and dried in vacuum to obtain 3.0 g (yield: 90%) of pale yellow solid Intermediate F.

### Synthesis of Compound II (4,4′-bis[N-(3-(9-(4-fluorophenyl)-9H)carbazolyl)-N-phenylamino]biphenyl)

9.28 g of Intermediate E (9-(4-fluorophenyl)-3-iodo-9H-carbazole) (24.0 mmol), 3.36 g of Intermediate F (10.0 mmol), 2.88 g of t-BuONa (30.0 mmol), 180 mg of Pd₂(dba)₃ (0.20 mmol), and 40 mg of P(t-Bu)₃ (0.20 mmol) were dissolved in 70 ml of toluene, and then stirred at 90° C. for 3 hours. After the reaction was terminated, the reaction mixture was cooled to room temperature. Then, distilled water was added thereto and the resultant was extracted three times using 30 ml of diethylether. The obtained organic layer was dried with anhydrous MgSO₄, filtered and dried under low pressure to obtain a product. The product was purified with silicagel column chromatography to obtain 5.98 g (yield: 70%) of yellow solid Compound II characterized by ¹H NMR (Acetone-D6, 400 MHz) δ (ppm) 7.95 (s, 4H), 7.57 (s, 4H), 7.37-6.92 (m, 32H); ¹³C NMR (Acetone-D6, 100 MHz) δ (ppm) 161.0, 158.6, 146.6, 145.6, 139.7, 138.8 (d), 136.3, 131.8, 128.1 (d), 126.5, 125.8, 122.5, 121.8, 121.5, 120.0, 119.4, 117.3, 114.4, 109.6, 108.0.

The obtained Compound II was diluted in CHCl₃ to a concentration of 0.2 mM to obtain a UV Spectrum. A maximum absorption wavelength of 351 nm was observed.

In addition, Compound II was thermally analyzed using TGA and DSC (under N₂ atmosphere, temperature range: room temperature ˜600° C. (10° C./min)-TGA, room temperature to 400° C.-DSC, Pan Type: Pt Pan in disposable Al Pan(TGA), disposable Al pan(DSC)) to obtain a Td of 438° C. and a Tg of 154° C.

A HOMO energy level of 5.10 eV and LOMO energy level of 2.07 eV were obtained using AC-2, that is, an UV absorption spectrum and ion potential measuring device.

### Synthesis Example 3

### Preparation of Compound 12 (4,4′-bis[N-(3-(9-(4-fluorophenyl)-9H)carbazolyl)-N-(4-methyl-phenyl)amino]biphenyl)

Compound 12 was synthesized according to Reaction Scheme 4 below.

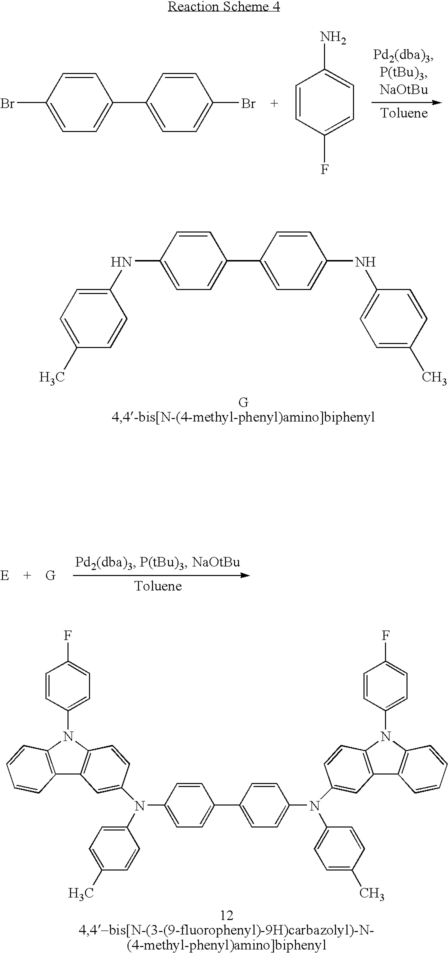

### Synthesis of Intermediate G (4,4′-bis[N-(4-methyl-phenyl)amino]biphenyl)

3.12 g of 4,4′-dibromodiphenyl (10 mmol), 2.68 g of toluidine (25 mmol), 2.9 g of t-BuONa (30 mmol), 183 mg of Pd₂(dba)₃ (0.2 mmol), and 40 mg of P(t-Bu)₃ (0.2 mmol) were dissolved in 50 ml of toluene, and then stirred 90° C. for 3 hours. A reaction mixture was cooled to room temperature, and then distilled water and diethylether were added thereto. Then, an undissolved solid material was filtered, washed using acetone and diethylether and dried in vacuum to obtain 2.99 g (yield: 82%) of gray solid Intermediate G.

### Synthesis of Compound 12 (4,4′-bis[N-(3-(9-(4-fluorophenyl)-9H)carbazolyl)-N-(4-methyl-phenyl)amino]biphenyl)

9.28 g of Intermediate E (9-(4-fluorophenyl)-3-iodo-9H-carbazole) (24.0 mmol), 3.66 g of Intermediate G (10.0 mmol), 2.88 g of t-BuONa (30.0 mmol), 180 mg of Pd₂(dba)₃ (0.20 mmol), and 40 mg of P(t-Bu)₃ (0.20 mmol) were dissolved in 70 ml of toluene, and then stirred at 90° C. for 3 hours. After the reaction was terminated, the reaction mixture was cooled to room temperature. Then, distilled water was added thereto and the resultant was extracted three times using 30 ml of diethylether. The obtained organic layer was dried with anhydrous MgSO₄, filtered and dried under low pressure to obtain a product. The product was purified with silicagel column chromatography to obtain 5.65 g (yield: 64%) of yellow solid Compound 12 characterized by ¹H NMR (Benzene-D6, 400 MHz) δ (ppm) 8.14 (d, 2H), 7.64 (d, 2H), 7.46 (d, 4H), 7.31-6.95 (m, 30H), 2.12 (s, 6H); ¹³C NMR (CDCl₃, 100 MHz) δ (ppm) 162.2, 159.8, 149.0, 147.4, 142.3 (d), 139.0, 138.8, 135.0, 132.5, 130.7 (d), 128.0, 127.9, 127.1, 126.5, 125.8, 125.0, 124.4, 123.6, 121.8, 121.0, 119.2, 111.7, 110.7, 21.5.

The obtained Compound 12 was diluted in CHCl₃ to a concentration of 0.2 mM to obtain a UV Spectrum. A maximum absorption wavelength of 351 nm was observed.

In addition, Compound 12 was thermally analyzed using TGA and DSC (under N₂ atmosphere, temperature range: room temperature ˜600° C. (10° C./min)-TGA, room temperature to 400° C.-DSC, Pan Type: Pt Pan in disposable Al Pan(TGA), disposable Al pan(DSC)) to obtain a Td of 408° C. and a Tg of 157° C.

A HOMO energy level of 5.10 eV and LOMO energy level of 2.08 eV were obtained using AC-2, that is, a UV absorption spectrum and ion potential measuring device.

### Synthesis Example 4

### Preparation of Compound 15 (4,4′-bis[N-(3-(9-(4-fluorophenyl)-9H)carbazolyl)-N-(4-fluoro-Phenyl)amino]biphenyl)

Compound 15 was synthesized according to Reaction Scheme 5 below.

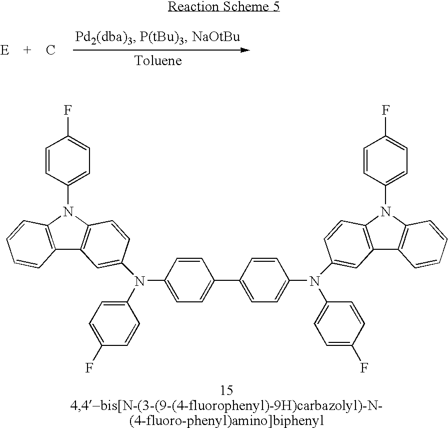

### Synthesis of Compound 15 (4,4′-bis[N-(3-(9-(4-fluorophenyl)-9H)carbazolyl)-N-(4-fluoro-phenyl)amino]biphenyl)

9.28 g of Intermediate E (9-(4-fluorophenyl)-3-iodo-9H-carbazole) (24.0 mmol), 3.72 g of Intermediate C (10.0 mmol), 2.88 g of t-BuONa (30.0 mmol), 180 mg of Pd₂(dba)₃ (0.20 mmol), and 40 mg of P(t-Bu)₃ (0.20 mmol) were dissolved in 70 ml of toluene, and then stirred at 90° C. for 3 hours.

After the reaction was terminated, the reaction mixture was cooled to room temperature. Then, distilled water was added thereto and the resultant was extracted three times using 30 ml of diethylether. The obtained organic layer was dried with anhydrous MgSO₄, filtered and dried under low pressure to obtain a product. The product was purified with silicagel column chromatography to obtain 5.97 g (yield: 67%) of weak yellow solid Compound 15 characterized by ¹H NMR (CDCl₃, 400 MHz) δ (ppm) 7.99 (d, 2H), 7.90 (s, 1H), 7.54-7.51 (m, 4H), 7.42-7.37 (m, 6H), 7.31-7.21 (m, 12H), 7.12-7.07 (m, 6H), 6.98-6.94 (t, 4H); ¹³C NMR (CDCl₃, 100 MHz) δ (ppm) 162.8, 160.4, 159.6, 157.2, 147.5, 144.4, 141.5, 140.6, 138.1, 133.5, 128.9 (d), 127.1, 126.3, 125.2, 124.3, 122.9, 121.9, 120.5, 120.0, 118.0, 116.9 (d), 115.9 (d), 110.5, 109.6.

The obtained Compound 15 was diluted in CHCl₃ to a concentration of 0.2 mM to obtain a UV Spectrum. A maximum absorption wavelength of 351 nm was observed.

In addition, Compound 15 was thermally analyzed using TGA and DSC (under N₂ atmosphere, temperature range: room temperature ˜600° C. (10° C./min)-TGA, room temperature to 400° C.-DSC, Pan Type: Pt Pan in disposable Al Pan(TGA), disposable Al pan(DSC)) to obtain a Td of 442° C., a Tg of 151° C., a Tm of 306° C., and a crystallization temperature Tc of 218° C.

A HOMO energy level of 5.05 eV and LOMO energy level of 2.25 eV were obtained using AC-2, that is, an UV absorption spectrum and ion potential measuring device.

### Synthesis Example 5

### Preparation of Compound 49 (4,4′-bis[N-(3-(9-(4-fluorophenyl)-9H)carbazolyl)-N-phenylamino]octafluorobiphenyl)

Compound 49 was synthesized according to Reaction Scheme 6 below.

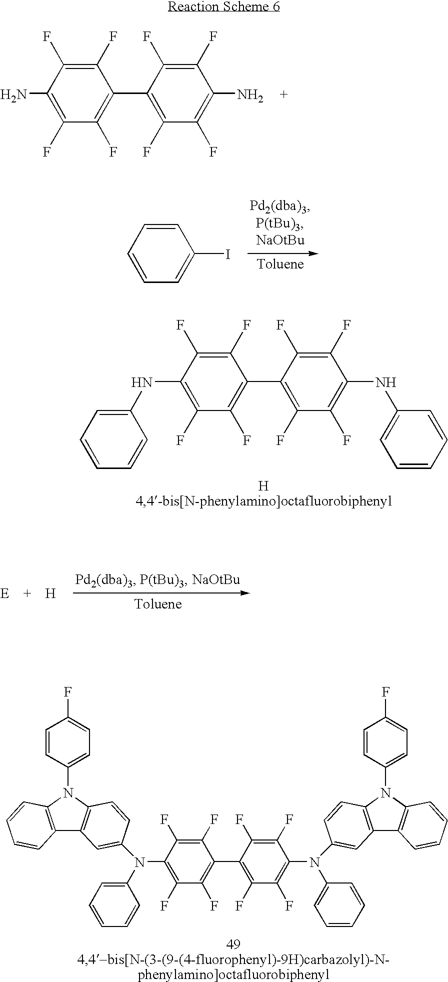

### Synthesis of Intermediate H (4,4′-bis[N-phenylamino]octafluorobiphenyl)

3.28 g of 4,4′-Diaminooctafluorobiphenyl (10.0 mmole), 4.90 g of iodobenzene (24 mmole), 2.88 g of t-BuONa (30 mmol), 183 mg of Pd₂(dba)₃ (0.20 mmol), and 40 mg of P(t-Bu)₃ (0.20 mmol) were dissolved in 80 ml of toluene, and then stirred at 90° C. for 5 hours. The reaction mixture was cooled to room temperature, and then distilled water and diethylether were added thereto. Then, an undissolved solid material was filtered, washed using acetone and diethylether and dried in vacuum to obtain 5.10 g (yield: 61%) of gray solid Intermediate H.

### Synthesis of Compound 49 (4,4′-bis[N-(3-(9-(4-fluorophenyl)-9H)carbazolyl)-N-phenylamino]octafluorobiphenyl)

9.28 g of Intermediate E (9-(4-fluorophenyl)-3-iodo-9H-carbazole) (24.0 mmol), 3.36 g of Intermediate H (4,4′-bis[N-phenylamino]octafluorobiphenyl) (10.0 mmol), 2.88 g of t-BuONa (30.0 mmol), 180 mg of Pd₂(dba)₃ (0.20 mmol), and 40 mg of P(t-Bu)₃ (0.20 mmol) were dissolved in 70 ml of toluene, and then stirred at 90° C. for 5 hours. After the reaction was terminated, the reaction mixture was cooled down to room temperature. Then, distilled water was added thereto and the resultant was extracted three times using 30 ml of diethylether. The obtained organic layer was dried with anhydrous MgSO₄, filtered and dried under low pressure to obtain a product. The product was purified with silicagel column chromatography to obtain 5.09 g (yield: 51%) of weak yellow solid Compound 49 characterized by ¹H NMR (CDCl₃, 400 MHz) δ (ppm) 7.92 (d, 2H), 7.58 (d, 2H), 7.45 (d, 4H), 7.29-7.13 (m, 24H); ¹³C NMR (CDCl₃, 100 MHz) δ (ppm) 161.6 (d), 158.4 (d), 146.4 (d), 144.4 (d), 140.4, 139.5, 137.0, 132.4 (d), 128.8 (d), 126.0, 125.2, 124.1, 123.2, 121.8, 120.8, 119.4, 118.9, 116.9, 115.6, 115.0, 114.9, 114.8, 109.4, 108.8.

The obtained Compound 49 was diluted in CHCl₃ to a concentration of 0.2 mM to obtain a UV Spectrum. A maximum absorption wavelength of 341 nm was observed.

In addition, Compound 49 was thermally analyzed using TGA and DSC (under N₂ atmosphere, temperature range: room temperature ˜600° C. (10° C./min)-TGA, room temperature to 400° C.-DSC, Pan Type: Pt Pan in disposable Al Pan(TGA), disposable Al pan(DSC)) to obtain a Td of 489° C. and a Tg of 171° C.

A HOMO energy level of 5.23 eV and LOMO energy level of 2.17 eV were obtained using AC-2, that is, a UV absorption spectrum and ion potential measuring device.

### Example 1

As an anode, a 15 Ω/cm² (1200 Å) ITO glass substrate was cut to a size of 50 mm×50 mm×0.7 mm, sonicating-washed with isopropyl alcohol and pure water for 5 minutes, respectively. The ITO glass substrate was irradiated with ultraviolet rays for 30 minutes and washed with ozone, and then installed in a vacuum deposition device.

A compound IDE406 (Idemitsu Co.) was vacuum-deposited on the glass substrate to form a first hole injection layer (HIL 1) having a thickness of 300 Å. Then, Compound 3 according to aspects of the present invention was vacuum-deposited on the first hole injection layer to form a second hole injection layer (HIL 2) having a thickness of 300 Å. Subsequently, 4,4′-bis[N-(1-naphthyl)-N-phenylamino]biphenyl (NPB), a hole transporting compound, was vacuum-deposited on the second hole injection layer to form a hole transport layer (HTL) having a thickness of 300 Å.

A blue fluorescent host IDE215 (Idemitsu Co.) and a blue fluorescent dopant IDE118 (Idemitsu Co.) in a weight ratio of 98 to 2 were simultaneously deposited on the hole transport layer to form an emissive layer (EML) having a thickness of 200 Å.

Next, Alq₃ was deposited on the emissive layer to form an electron transport layer (ETL) having a thickness of 300 Å, a halogenized alkali metal, LiF, was deposited on the electron transport layer (ETL) to form an electron injection layer (EIL) having a thickness of 10 Å, and Al was vacuum deposited to form an LiF/Al electrode, a cathode, having a thickness of 3000 Å. As a result, the manufacture of an organic light emitting diode was completed.

The organic light emitting diode exhibited a turn-on voltage of 7.32 V at a current density of 100 mA/cm², a relatively high brightness of 7,041 cd/m², a color coordinate of (0.143, 0.243), and a light emitting efficiency of 7.04 cd/A.

### Example 2

An organic light emitting diode was manufactured in the same manner as in Example 1, except that Compound 3 was used instead of IDE406 in the process of forming the first hole injection layer (HIL 1).

The organic light emitting diode exhibited a turn-on voltage of 7.18 V at a current density of 100 mA/cm², a relatively high brightness of 7,110 cd/m², a color coordinate of (0.143, 0.244), and a light emitting efficiency of 7.11 cd/A.

### Example 3

An organic light emitting diode was manufactured in the same manner as in Example 1, except that Compound 15 was used instead of Compound 3 in the process of forming the second hole injection layer (HIL 2).

The organic light emitting diode exhibited a turn-on voltage of 7.4 V at a current density of 100 mA/cm², a relatively high brightness of 6,528 cd/m², a color coordinate of (0.143, 0.243), and a light emitting efficiency of 6.53 cd/A.

### Example 4

An organic light emitting diode was manufactured in the same manner as in Example 3, except that Compound 15 was used instead of IDE406 in the process of forming the first hole injection layer (HIL 1).

The organic light emitting diode exhibited a turn-on voltage of 7.08 V at a current density of 100 mA/cm², a relatively high brightness of 6,915 cd/m², a color coordinate of (0.143, 0.242), and a light emitting efficiency of 6.92 cd/A.

### Comparative Example 1

An organic light emitting diode was manufactured in the same manner as in Example 1, except that IDE406 (Idemitsu Co.) was used instead of Compound 3 in the process of forming the second hole injection layer (HIL 2).

The organic light emitting diode exhibited a turn-on voltage of 7.75 V at a current density of 100 mA/cm², a brightness of 6,219 cd/m², a color coordinate of (0.143, 0.243), and a light emitting efficiency of 6.22 cd/A.

In the organic light emitting diodes of the Examples 1 through 4 and the Comparative Example 1, light generated in the organic layers (OL) of the organic light emitting diodes was emitted through the first electrodes (the anodes). With respect to compounds used in the first hole injection layers (HIL 1) and second hole injection layers (HIL 2) of the organic light emitting diodes of the Examples 1 through 4 and the Comparative Example 1, turn-on voltages, brightnesses, color coordinates, and light emitting efficiencies of the organic light emitting diodes are shown in Table 1 below.

TABLE 1

| | First hole | Second hole | | | | Light |
|---|---|---|---|---|---|---|
| | injection | injection | Turn-on | | | emitting |
| | layer (HIL 1) | layer (HIL 2) | voltage (V at | Brightness | Color | efficiency |
| | (thickness: 300 Å) | (thickness: 300 Å) | 100 mA/cm²) | (cd/m²) | coordinate | (cd/A) |
| Example 1 | IDE 406 | Compound 3 | 7.32 | 7041 | (0.143, 0.243) | 7.04 |
| Example2 | Compound 3 | Compound 3 | 7.18 | 7110 | (0.143, 0.244) | 7.11 |
| Example 3 | IDE 406 | Compound 15 | 7.4 | 6528 | (0.143, 0.243) | 6.53 |
| Example 4 | Compound 15 | Compound 15 | 7.08 | 6915 | (0.143, 0.242) | 6.92 |
| Comparative | IDE 406 | IDE 406 | 7.75 | 6219 | (0.143, 0.243) | 6.22 |
| Example 1 | | | | | | |

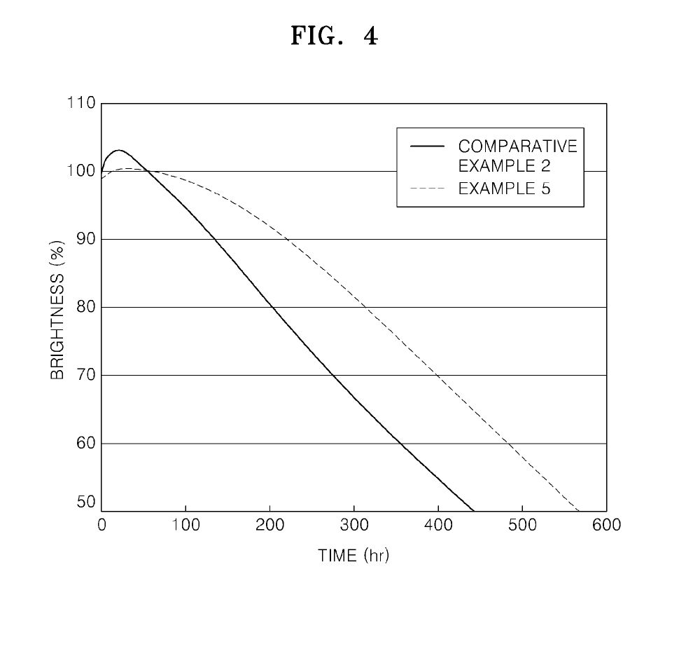

Comparing the light emitting efficiencies, turn-on voltages, brightnesses, and the like, it can be seen that the organic light emitting diodes of the Examples 1 through 4 have better hole transporting ability than that of the Comparative Example 1. In addition, FIG. 3 is a graph showing lifetimes of the organic light emitting diodes of the Examples 1 through 4 and the Comparative Example 1 at a current density of 100 mA/cm². In the case of using Compound 3 or Compound 15 as the first hole injection layer (HIL 1) material and the second hole injection layer (HIL 2) material (that is, in the Examples 2 and 4), the organic light emitting diodes of Examples 2 and 4 had 33% and 24%, respectively, longer lifetimes than that of the Comparative Example 1. In particular, in the case of using Compound 3 or Compound 15 as the second hole injection layer (HIL 2) material (that is, the Examples 1 and 3), the organic light emitting diodes of the Examples 1 and 3 exhibited a significant lifetime increase of 50% or more as compared to the Comparative Example 1.

### Example 5

As a reflective pixel electrode (a first electrode), an Al and ITO substrate having a thickness of 1300 Å was cut to a size of 50 mm×50 mm×0.7 mm, and sonicating-washed with isopropyl alcohol and pure water for 5 minutes, respectively. The Al and ITO substrate was irradiated with ultraviolet rays for 30 minutes and washed with ozone.

A compound IDE406 (Idemitsu Co.) was vacuum deposited on the pixel electrode to form a first hole injection layer (HIL 1) having a thickness of 600 Å, Compound 3 according to aspects of the present invention was deposited on the first hole injection layer (HIL 1) to form a second hole injection layer (HIL 2) having a thickness of 600 Å, and then a hole transporting material NPB was deposited on the second hole injection layer (HIL 2) to form a hole transport layer (HTL) having a thickness of 300 Å.

A blue fluorescent host IDE215 (Idemitsu Co.) and a blue fluorescent dopant IDE118 (Idemitsu Co.) in a weight ratio of 98 to 2 were simultaneously deposited on the hole transport layer (HTL) to form a blue emissive layer (EML) having a thickness of 300 Å. Then, Balq was deposited on the blue emissive layer (EML) to form a hole blocking layer (HBL) having a thickness of 50 Å. Alq₃ was deposited on the hole blocking layer (HBL) to form an electron transport layer (ETL) having a thickness of 250 Å. Then, a halogenized alkali metal, LiF, was deposited on the electron transport layer (ETL) to form an electron injection layer (EIL) having a thickness of 3 Å, and MgAg was deposited on the electron injection layer (EIL) to form a transparent electrode (a second electrode) having a thickness of 180 Å. As a result, the manufacture of an organic light emitting diode was completed.

The organic light emitting diode exhibited a turn-on voltage of 5.05 V at a current density of 11.71 mA/cm², a brightness of 420 cd/m², a color coordinate of (0.124, 0.077), and a light emitting efficiency of 3.1 cd/A.

### Comparative Example 2

An organic light emitting diode was manufactured in the same manner as in Example 5, except that IDE406 (Idemitsu Co.) was used instead of Compound 3 in the process of forming the second hole injection layer (HIL 2).

The organic light emitting diode exhibited a turn-on voltage of 5.15 V at a current density of 13.88 mA/cm², a brightness of 348 cd/m², a color coordinate of (0.132, 0.091), and a light emitting efficiency of 2.5 cd/A.

In the organic light emitting diodes of the Example 5 and the Comparative Example 2, light generated in organic layers of the organic light emitting diodes was emitted through the second electrodes. With respect to compounds used in the first hole injection layers (HIL 1) and second hole injection layers (HIL 2) of the organic light emitting diodes of the Example 5 and the Comparative Example 2, turn-on voltages, brightnesses, color coordinates, and light emitting efficiencies of the organic light emitting diodes are shown in Table 2 below.

TABLE 2

| | | | Current | | | |
|---|---|---|---|---|---|---|
| | | | density | | | |
| | First hole | Second hole | mA/cm²(at a | | | Light |
| | injection | injection | turn-on | | | emitting |
| | layer (HIL 1) | layer (HIL 2) | voltage of | Brightness | Color | efficiency |
| | (thickness: 600 Å) | (thickness: 600 Å) | about 5 V) | (cd/m²) | coordinate | (cd/A) |
| Example 5 | IDE 406 | Compound 3 | 11.71 | 420 | (0.124, 0.077) | 3.1 |
| Comparative | IDE 406 | IDE 406 | 13.88 | 348 | (0.132, 0.091) | 2.5 |
| Example 2 | | | | | | |

Comparing light emitting efficiencies, current densities, life-times, and the like, it can be seen that the organic light emitting diode of the Example 5 has better hole transporting ability than that of the Comparative Example 2. In addition, FIG. 4 is a graph showing lifetimes of the organic light emitting diodes of the Example 5 and the Comparative Example 2 at a current density of 50 mA/cm². In the Example 5 using Compound 3 according to aspects of the present invention as the second hole injection layer (HIL 2) material, the organic light emitting diode of the Example 5 had about a 30% longer lifetime than that of the Comparative Example 2.

In general, when electrons from an emissive layer (EML) collide with a hole transport layer (HTL), a hole transporting ability of the hole transport layer (HTL) deteriorates. Consequently, properties of a device including the hole transport layer (HTL) are deteriorated, and thus lifetime of the device is shortened. However, a compound represented by Formula 1 according to aspects of the present invention having a fluorine group that can trap electrons significantly prevents the hole transporting ability of the hole transport layer (HTL) from deteriorating when electrons collide with the hole transport layer (HTL). Therefore, a hole injection layer (HIL) comprising the compound of Formula 1 stabilizes the organic light emitting diode when electrons collide with the hole injection layer (HIL). As a result, the lifetime of the organic light emitting diode including the hole injection layer (HIL) according to aspects of the present invention is significantly increased. Further, an organic light emitting diode according to aspects of the present invention may eliminate the need for a specific electron blocking layer included in the conventional organic light emitting diode.

Although a few embodiments of the present invention have been shown and described, it would be appreciated by those skilled in the art that changes may be made in this embodiment without departing from the principles and spirit of the invention, the scope of which is defined in the claims and their equivalents.

1. An organic light emitting diode, comprising:
a substrate;
a first electrode formed on the substrate;
a second electrode; and
an organic layer disposed between the first electrode and the second electrode,
wherein the organic layer comprises an emissive layer, a first hole injection layer, and a second hole injection layer, and at least one of the first hole injection layer and the second hole injection layer comprises a compound represented by Formula 1 below: 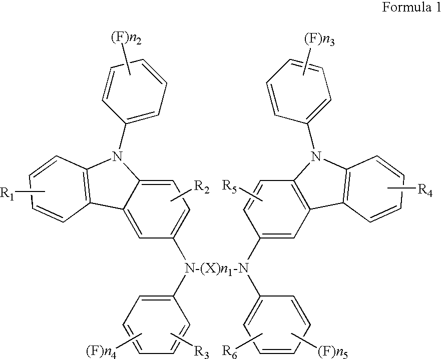
wherein X is a substituted or unsubstituted C₆-C₃₀ arylene group, a substituted or unsubstituted C₂-C₃₀ heteroarylene group, or a substituted or unsubstituted C₁-C₃₀ alkylene group;
R₁, R₂, R₃, R₄, R₅, and R₆ are each independently a hydrogen atom, a hydroxyl group, a cyano group, a substituted or unsubstituted C₁-C₃₀ alkyl group, a substituted or unsubstituted C₁-C₃₀ alkoxy group, a substituted or unsubstituted C₆-C₃₀ aryl group, a substituted or unsubstituted C₂-C₃₀ aryloxy group, a substituted or unsubstituted C₂-C₃₀ heteroaryl group, or a group represented by —N(Z₁)(Z₂) where Z₁ and Z₂ are each independently hydrogen, a C₁-C₃₀ alkyl group, a C₁-C₃₀ alkoxy group or a C₆-C₃₀ aryl group, and at least two adjacent groups of R₁, R₂, R₃, R₄, R₅, and R₆ maybe bound to form a saturated or unsaturated carbon ring; and
n₁, n₂ n₃, n₄, and n₅ are each independently an integer of 0 through 5, provided that n₁, n₂, n₃, n₄, and n₅ are not all 0,
wherein the compound represented by Formula 1 contains at least one F.

2. The organic light emitting diode of claim 1, wherein X is one of a plurality of structures represented by Formula 2: 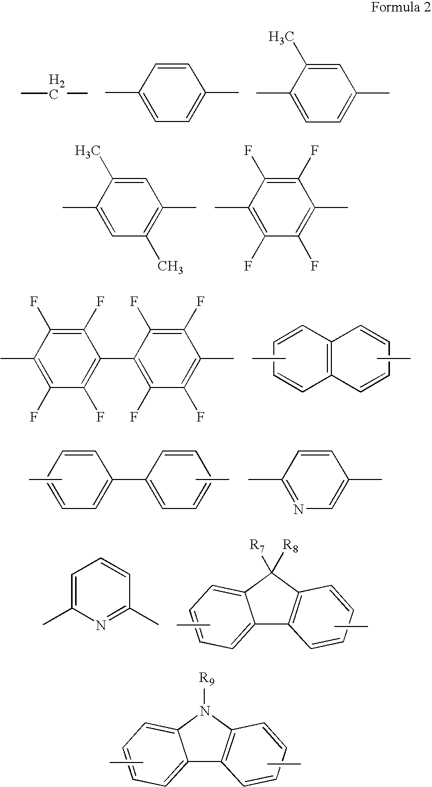
wherein R₇, R₈, and R₉ are each independently a hydrogen atom, a hydroxyl group, a cyano group, a substituted or unsubstituted C₁-C₃₀ alkyl group, a substituted or unsubstituted C₁-C₃₀ alkoxy group, a substituted or unsubstituted C₆-C₃₀ aryl group, a substituted or unsubstituted C₆-C₃₀ aryloxy group, a substituted or unsubstituted C₂-C₃₀ heteroaryl group, or a group represented by —N(Z₁)(Z₂) where Z₁ and Z₂ are each independently hydrogen, a C₁-C₃₀ alkyl group, a C₁-C₃₀ alkoxy group or a C₆-C₃₀ aryl group, and at least two adjacent groups of R₇, R₈ and R₉, if present, may be bound to form a saturated or unsaturated carbon ring.

3. The organic light emitting diode of claim 1, wherein R₁, R₂, R₃, R₄, R₅, and R₆ are each independently a hydrogen atom, a hydroxyl group, a cyano group, a substituted or unsubstituted C₁-C₁₀ alkyl group, a substituted or unsubstituted C₆-C₁₂ aryl group, a substituted or unsubstituted C₂-C₁₂ heteroaryl group, or a group represented by —N(Z₁)(Z₂) where Z₁ and Z₂ are each independently hydrogen, a C₁-C₃₀ alkyl group, a C₁-C₃₀ alkoxy group or a C₆-C₃₀ aryl group.

4. The organic light emitting diode of claim 1, wherein R₁, R₂, R₃, R₄, R₅, and R₆ are each independently one of a plurality of structures represented by Formula 3:

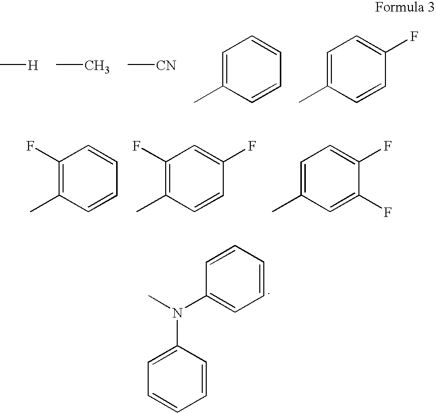

5. The organic light emitting diode of claim 1, wherein n₂ and n₃ are each independently 1 or 2.

6. The organic light emitting diode of claim 1, wherein n₄ and n₅ are each independently 1, 2, or 3.

7. The organic light emitting diode of claim 1, wherein the compound represented by Formula 1 is one of Compounds 3, 11, 12, 15, and 49 below:

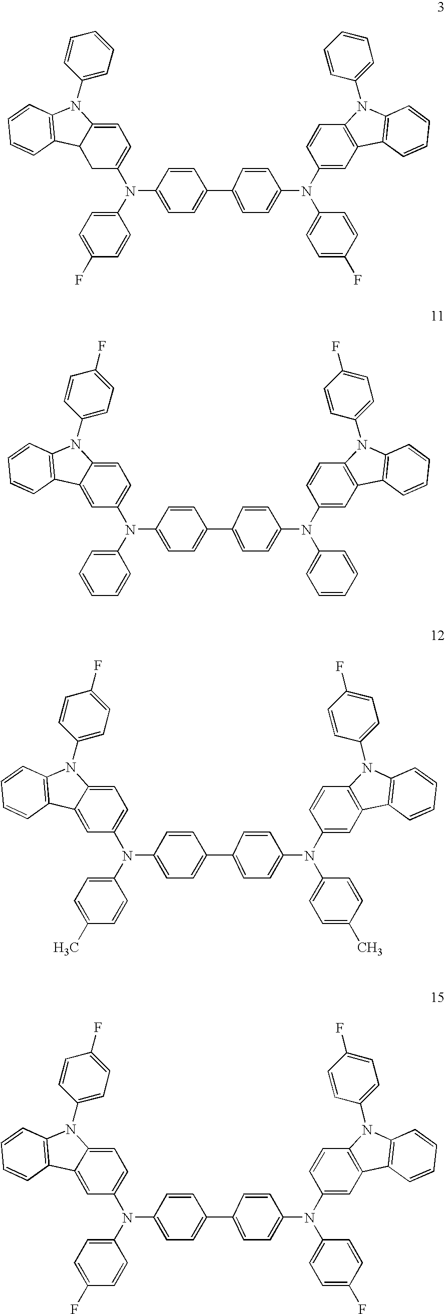

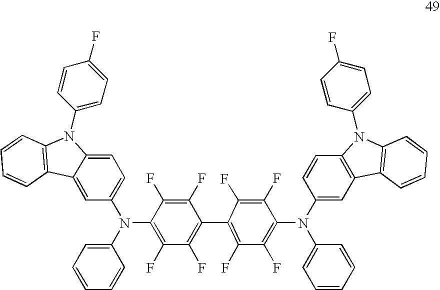

8. The organic light emitting diode of claim 1, wherein each of the first hole injection layer and the second hole injection layer comprises the compound of Formula 1.

9. The organic light emitting diode of claim 1, wherein one of the first hole injection layer and the second hole injection layer comprises the compound of Formula 1.

10. The organic light emitting diode of claim 1, wherein, when the first hole injection layer is formed between the second hole injection layer and the substrate, the second hole injection layer comprises the compound of Formula 1.

11. The organic light emitting diode of claim 1, wherein the organic light emitting diode is operable such that resonance occurs between the first electrode and the second electrode.

12. The organic light emitting diode of claim 1, wherein a combined thickness of the first hole injection layer and the second hole injection layer is 50-2000 Å.

13. The organic light emitting diode of claim 12, wherein the combined thickness of the first hole injection layer and the second hole injection layer is 100-1000 Å.

14. The organic light emitting diode of claim 12, wherein a thickness of the at least one of the first hole injection layer and the second hole injection layer comprising the compound of Formula 1 is 50% or less of the combined thickness of the first hole injection layer and the second hole injection layer.

15. The organic light emitting diode of claim 1, wherein a combined thickness of the first hole injection layer and the second hole injection layer is 50-800 Å.

16. The organic light emitting diode of claim 15, wherein the combined thickness of the first hole injection layer and the second hole injection layer is 100-400 Å.

17. The organic light emitting diode of claim 15, wherein a thickness of the at least one of the first hole injection layer and the second hole injection layer comprising the compound of Formula 1 is 50% or less of the combined thickness of the first hole injection layer and the second hole injection layer.

18. The organic light emitting diode of claim 1, wherein n₂, n₃, n₄, and n₅ are 0.

19. A display device, comprising:
the organic light emitting diode according to claim 1; and
a thin film transistor,
wherein the first electrode of the organic light emitting diode and a source electrode or a drain electrode of the thin film transistor are electrically connected.

20. An organic light emitting diode, comprising:
a substrate;
a first electrode formed on the substrate;
a second electrode; and
an organic layer disposed between the first electrode and the second electrode,
wherein the organic layer comprises an emissive layer, a hole transport layer, and a hole injection layer, and at least one of the hole transport layer and the hole injection layer comprises a compound represented by Formula 1 below: 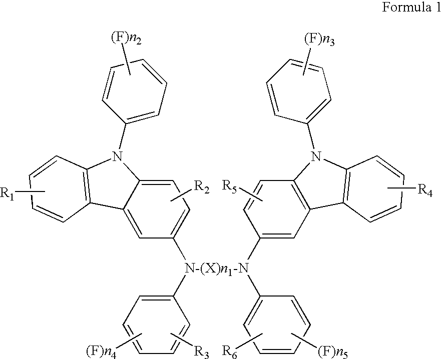
wherein X is a substituted or unsubstituted C₆-C₃₀ arylene group, a substituted or unsubstituted C₂-C₃₀ heteroarylene group, or a substituted or unsubstituted C₁-C₃₀ alkylene group;
R₁, R₂, R₃, R₄, R₅, and R₆ are each independently a hydrogen atom, a hydroxyl group, a cyano group, a substituted or unsubstituted C₁-C₃₀ alkyl group, a substituted or unsubstituted C₁-C₃₀ alkoxy group, a substituted or unsubstituted C₆-C₃₀ aryl group, a substituted or unsubstituted C₆-C₃₀ aryloxy group, a substituted or unsubstituted C₂-C₃₀ heteroaryl group, or a group represented by —N(Z₁)(Z₂) where Z₁ and Z₂ are each independently hydrogen, a C₁-C₃₀ alkyl group, a C₁-C₃₀ alkoxy group or a C₆-C₃₀ aryl group, and at least two adjacent groups of R₁, R₂, R₃, R₄, R₅, and R₆ maybe bound to form a saturated or unsaturated carbon ring; and
n₁, n₂ n₃, n₄, and n₅ are each independently an integer of 0 through 5, provided that n₁, n₂, n₃, n₄, and n₅ are not all 0,
wherein the compound represented by Formula 1 contains at least one F.
